(19) United States
(12) Patent Application Publication
(10) Pub. No.: US 2024/0404312 A1
(43) Pub. Date: Dec. 5, 2024

(54) Information Processing Apparatus, Method of Processing Information, and Non-Transitory Computer-Readable Storage Medium

(71) Applicant: YAMAHA CORPORATION, Hamamatsu-shi (JP)

(72) Inventors: Yuji MIURA, Hamamatsu-shi (JP); Keizo HARADA, Hamamatsu-shi (JP); Hideaki TAKEHISA, Hamamatsu-shi (JP)

(21) Appl. No.: 18/806,949

(22) Filed: Aug. 16, 2024

Related U.S. Application Data
(63) Continuation of application No. PCT/JP2022/006421, filed on Feb. 17, 2022.

(51) Int. Cl. G06V 40/10; G10D 13/10

(52) U.S. Cl. CPC G06V 40/103; G10D 13/10

(57) ABSTRACT

An information processing apparatus includes a first obtainer and a recommended information outputter. The first obtainer obtains configuration information and body information. The configuration information is regarding a configuration of a drumming instrument. The body information is regarding a body of a performer playing the drumming instrument. The recommended information outputter outputs recommended information based on the configuration information and the body information obtained by the first obtainer. The recommended information is regarding a setting for playing the drumming instrument and corresponds to the performer.

### CROSS-REFERENCE TO RELATED APPLICATIONS

The present application is a continuation application of International Application No. PCT/JP2022/006421, filed Feb. 17, 2022. The contents of this application are incorporated herein by reference in their entirety.

### BACKGROUND

The present disclosure relates to an information processing apparatus, a method of processing information, and a non-transitory computer-readable storage medium.

Japanese Translation of PCT International Application Publication No. JP-T-2015-507178 discloses a device that allows for positioning and re-positioning of the device relative to a microphone, a stand, a transducer, a musical instrument, an amplifier-equipped speaker unit, and a piece of furniture.

As recited in No. JP-T-2015-507178, it is important to set up a musical instrument (hereinafter referred to as “instrument”) at the time of playing the instrument.

It is an object of the present disclosure to provide an information processing apparatus that allows for assisting with setting up a drum. It is another object of the present disclosure to provide a method that allows for assisting with setting up a drum. It is another object of the present disclosure to provide a non-transitory computer-readable storage medium that allows for assisting with setting up a drum.

### SUMMARY

One aspect is an information processing apparatus that includes a first obtainer and a recommended information outputter. The first obtainer is configured to obtain configuration information and body information. The configuration information is regarding a configuration of a drumming instrument. The body information is regarding a body of a performer playing the drumming instrument. The recommended information outputter is configured to output recommended information based on the configuration information and the body information obtained by the first obtainer. The recommended information is regarding a setting for playing the drumming instrument and corresponds to the performer.

Another aspect is a computer system-implemented method of processing information. The method includes obtaining configuration information and body information. The configuration information is regarding a configuration of a drumming instrument. The body information is regarding a body of a performer playing the drumming instrument. The method also includes outputting recommended information based on the configuration information and the body information that have been obtained. The recommended information is regarding a setting for playing the drumming instrument and corresponds to the performer.

Another aspect is a non-transitory computer-readable storage medium storing a program. When the program is executed by at least one processor, the program causes the at least one processor to obtain configuration information and body information. The configuration information is regarding a configuration of a drumming instrument. The body information is regarding a body of a performer playing the drumming instrument. The program also causes the at least one processor to output recommended information based on the configuration information and the body information that have been obtained. The recommended information is regarding a setting for playing the drumming instrument and corresponds to the performer.

A more complete appreciation of the present disclosure and many of the attendant advantages thereof will be readily obtained as the same becomes better understood by reference to the following detailed description when considered in connection with the following figures, in which:

### BRIEF DESCRIPTION OF THE DRAWINGS

FIG. 1 is a schematic illustration of an example configuration of a drum setting assistance system according to one embodiment;

FIG. 2 is a flowchart illustrating an example basic operation of a smartphone;

FIG. 3 is a schematic illustration of an example configuration of a drum set;

FIG. 4 is a schematic illustration of a posture of a body of a performer playing the drum set;

FIG. 5 is a schematic illustration of a body state of the performer playing the drum set;

FIG. 6 is a schematic illustration of a body state of the performer playing the drum set;

FIG. 7 is a schematic illustration of an example in which recommended information is generated using a trained model;

FIG. 8 is a schematic illustration of teaching of the trained model using teaching data;

FIG. 9 is a schematic illustration of an example in which the recommended information is generated using a trained model that receives, as input information, extracted information extracted from a performance scene image;

FIG. 10 is a schematic illustration of how the trained model learns using teaching data;

FIG. 11 is a schematic illustration of an example in which the recommended information is generated using a trained model that receives, as input information, both the performance scene image and the extracted information;

FIG. 12 is a schematic illustration of how the trained model learns using teaching data;

FIG. 13 is a schematic illustration of the recommended information output by performing processing using a rule base;

FIG. 14 is a schematic illustration of the recommended information output by performing processing using a rule base;

FIG. 15 is a schematic illustration of the recommended information output by performing processing using a rule base;

FIG. 16 is a schematic illustration of a partially customized setting based on a manufacturer standard value;

FIG. 17 is a schematic illustration of a partially customized setting based on a manufacturer standard value;

FIG. 18 is a schematic illustration of a partially customized setting based on a manufacturer standard value;

FIG. 19 is a schematic illustration of a specific example of the output of the recommended information (display of a recommendation comment);

FIG. 20 is a schematic illustration of a specific example of the output of the recommended information (display of a recommendation comment);

FIG. 21 is a schematic illustration of a specific example of the output of the recommended information (a captured image of toms);

FIG. 22 is a schematic illustration of a specific example of the output of the recommended information (AR display of recommended information);

FIG. 23 is a schematic illustration of a specific example of the output of the recommended information (a captured image of the body of the performer);

FIG. 24 is a schematic illustration of a specific example of the output of the recommended information (AR display of recommended information);

FIG. 25 is a schematic illustration of a specific example of the output of the recommended information (a captured image of a room);

FIG. 26 is a schematic illustration of a specific example of the output of the recommended information (AR display of recommended information);

FIG. 27 is a schematic illustration of a specific example of the output of the recommended information (AR display of recommended information);

FIG. 28 is a schematic illustration of a specific example of the output of the recommended information (AR display of recommended information);

FIG. 29 is a schematic illustration of an example of a straight-type cymbal stand;

FIG. 30 is a schematic illustration of an example of a boom-type cymbal stand;

FIG. 31 is a block diagram illustrating another exemplary functional configuration of a smartphone;

FIG. 32 is a schematic illustration of an example configuration of electronic drums; and

FIG. 33 is a block diagram illustrating an example hardware configuration of a computer that can be used as an information processing apparatus.

### DESCRIPTION OF THE EMBODIMENTS

The present specification is applicable to an information processing apparatus, a method of processing information, and a non-transitory computer-readable storage medium.

The embodiments will now be described with reference to the accompanying drawings, wherein like reference numerals designate corresponding or identical elements throughout the various drawings.

### Drum Setting Assistance System

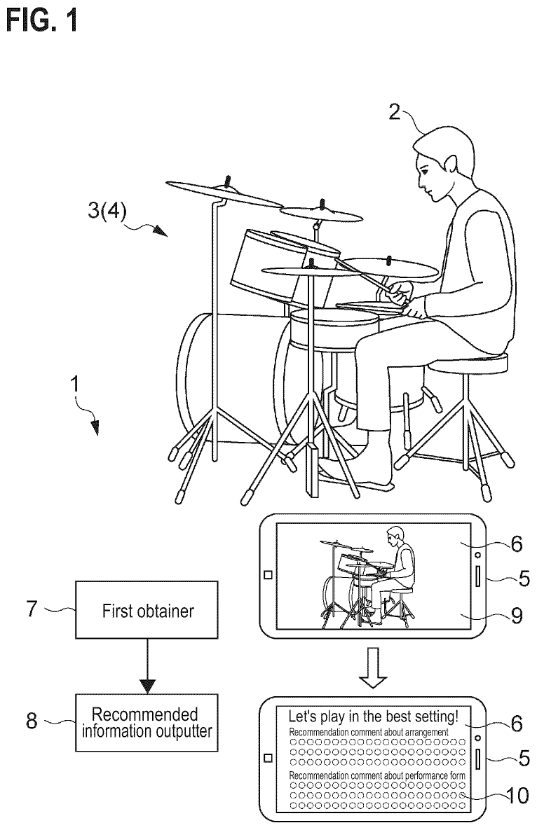

FIG. 1 is a schematic illustration of an example configuration of a drum setting assistance system 1 according to an embodiment. The drum setting assistance system 1 assists a performer (drummer) 2 with settings associated with playing of a drumming instrument 3. The performer 2 can also be referred to as a user of the drum setting assistance system 1.

As used herein, the term “drumming instrument” is intended to mean a musical instrument of any of various forms including a drum. In the embodiment illustrated in FIG. 1, a drum set 4 is shown as an example of the drumming instrument 3. The drum set 4, however, is not intended as limiting the drumming instrument 3. Other examples of the drumming instrument 3 include a Japanese drum, a percussion, and an electronic device such as an electronic drum.

The drum set 4 illustrated in FIG. 1 includes cymbals and other instruments that are not classified as drums themselves. These instruments, however, are frequently played together with drums. There are other pieces of equipment necessary for a performance, such as a chair.

For example, there may be a case that a Japanese drum is played together with a gong. There also may be a case that a percussion s played together with a wind chime, a cowbell, or a shaker. There also may be a case that an electronic cymbal is provided as an electronic drum set.

In the present disclosure, the drumming instrument 3 encompasses these other kinds of instruments played together with drums and pieces of equipment necessary for a performance. That is, settings to the cymbals and the chair illustrated in FIG. 1 can be assisted using the technique according to this embodiment.

Additionally, some performers strike objects such as pots, pans, desks, and tables, which are not originally designed as musical instruments, during their performance. In such performance, objects struck as musical instruments by the performer 2 will also be encompassed within the drum instrument 3.

In the embodiment illustrated in FIG. 1, the drum setting assistance system 1 is implemented by using the smartphone 5. The smartphone 5 is used as a computer with an imaging function.

The computer with an imaging function may have any configuration. Examples include a tablet terminal, an HMD (Head Mounted Display) such as an AR (Augmented Reality) glass and a VR (Virtual Reality) glass, and a PC (Personal Computer).

In this embodiment, the smartphone 5 serves as one embodiment of the information processing apparatus.

The smartphone 5 has hardware necessary for a computer configuration. Elements of such hardware include: a processor such as CPU, GPU, and DSP; a memory such as ROM and RAM, and a storage device such as HDD. For example, a program pertaining to the technique according to this embodiment is pre-recorded in the ROM. The CPU loads the program into the RAM and executes the program to perform the method of processing information according to this embodiment.

The smartphone 5 includes a camera (not illustrated). An example of the camera is a digital camera including an image sensor such as a CMOS (Complementary Metal-Oxide Semiconductor) sensor and a CCD (Charge Coupled Device) sensor.

The camera may also include an imaging device that may have any configuration.

In this embodiment, the camera of the smartphone 5 captures a scene of the performer 2 playing the drumming instrument 3.

The phrase “scene of the performer 2 playing the drumming instrument 3” is intended to encompass a scene of the performer 2 while moving the performer 2's body, a scene of the performer 2 ready for playing the drumming instrument 3 (a scene of the performer 2 on standby, ready to play the drumming instrument 3), and a scene of the performer 2 assuming a posture to play the drumming instrument 3.

For example, it will be assumed that the drumming instrument 3 is the drum set 4, as illustrated in FIG. 1. In this case, the scene of the performer 2 playing the drumming instrument 3 encompasses a scene of the performer 2 playing the drumming instrument 3 while maintaining a rhythm of 8 beats or 16 beats.

This configuration, however, is not intended in a limiting sense; the scene of the performer 2 playing the drumming instrument 3 may also encompass a scene of the performer 2 sitting on the chair beside the drum set 4 and ready to play the drum set 4 any time (a scene of the performer 2 on standby, sitting on the chair with drumsticks in hand).

The scene of the performer 2 playing the drumming instrument 3 may also encompass a scene of the performer 2 sitting on the chair beside the drum set 4 and assuming a posture to play the drum set 4. The scene of the performer 2 playing the drumming instrument 3 may also encompass a scene of the performer 2 sitting on the chair with the performer 2's body assuming a posture to play the drumming instrument 3 even if the performer 2 is without drumsticks.

A captured image of the scene of the performer 2 playing the drumming instrument 3 may be hereinafter occasionally referred to as performance scene image. The performance scene image is included in a captured image according to the technique of this embodiment. The captured image includes at least one of a configuration of the drumming instrument 3 or the body of the performer 2.

Also in the present disclosure, the term “image” is intended to encompass a still image, a sequence of still images, multiple still images spaced throughout time, or images in the form of a video.

The smartphone 5 also includes a touch panel 6. The touch panel 6 serves as a display section and an input section.

The touch panel 6 displays various kinds of image information such as icons, text, a GUI (Graphical User Interface), and captured images. Also in this embodiment, the touch panel 6 is capable of AR display. In AR display, the touch panel 6 displays an AR object (virtual image) superimposed over a real image.

The performer 2 can execute various touch commands on icons and other image information displayed on the touch panel 6. This enables the performer 2 to input various instructions into the information processing apparatus.

The smartphone 5 may also include various devices such as a microphone, a speaker, a GPS, and an IMU (Inertial Measurement Unit) sensor.

As illustrated in FIG. 1, in this embodiment, the CPU and other elements of the smartphone 5 execute a predetermined program to implement functional blocks, namely, a first obtainer 7 and a recommended information outputter 8. It will be readily appreciated, however, that dedicated hardware such as an IC (integrated circuit) may be used to implement the functional blocks.

The predetermined program may be installed in the smartphone 5 via various storage media. Another possible example is that the program is installed via the Internet or another network.

There is no limitation to the storage medium in which the program is recorded; any computer-readable storage medium may be used. For example, any non-transitory computer-readable storage medium may be used.

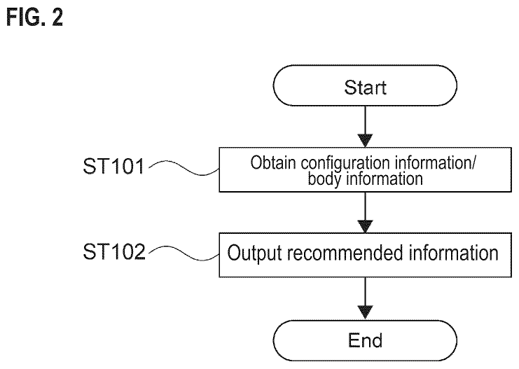

FIG. 2 is a flowchart illustrating an example basic operation of the smartphone 5.

The first obtainer 7 obtains configuration information and body information (step S101). The configuration information is regarding a configuration of the drumming instrument 3. The body information is regarding the body of the performer 2 playing the drumming instrument 3.

The configuration information includes any information regarding the configuration of the drumming instrument 3. The body information includes any information regarding the body of the performer 2.

In the example illustrated in FIG. 1, the smartphone 5 captures a performance scene image 9 and displays the performance scene image 9 on the touch panel 6. The performance scene image 9 is a captured image including both the configuration information and the body information. In this embodiment, the first obtainer 7 obtains the performance scene image 9, which is captured by the smartphone 5, as the configuration information and the body information.

This configuration, however, is not intended as limiting the configuration information and the body information. Another possible example is that extracted information extracted from the performance scene image 9 is obtained as the configuration information or the body information. For example, any information regarding a configuration of the drumming instrument 3 may be extracted from the performance scene image 9 and obtained as the configuration information. Another possible example is that any information regarding the body of the performer 2 may be extracted from the performance scene image 9 and obtained as the body information.

Still another possible example is that information other than the performance scene image 9 and extracted information extracted from the performance scene image 9 is obtained as the configuration information and the body information. The obtaining of the configuration information and the body information will be described in detail later.

The recommended information outputter 8 outputs recommended information based on the configuration information and the body information obtained by the first obtainer 7 (step S102). The recommended information is regarding a setting for playing the drumming instrument 3 and corresponds to the performer 2.

In the example illustrated in FIG. 1, the touch panel 6 displays a recommendation comment 10 as the recommended information (the recommendation comment 10 is also illustrated in FIG. 19).

The recommendation comment 10 includes “Recommendation comment about arrangement”. This recommendation comment is included in recommended configuration information. The recommended configuration information is regarding a configuration of the drumming instrument 3 recommended for the body of the performer 2 in playing the drumming instrument 3.

The recommendation comment 10 also includes “Recommendation comment about performance form”. This recommendation comment is included in recommended body information. The recommended body information is regarding a recommended posture of the body of the performer 2 in playing the drumming instrument 3.

The recommendation comment 10, however, is not intended as limiting how to output the recommended information. The recommended information may be output in various other ways, such as displaying a virtual image and output a sound. The output of the recommended information will be described in detail later.

In the example illustrated in FIG. 1, the first obtainer 7 is one embodiment of the first obtainer according to this embodiment. The recommended information outputter 8 is one embodiment of the recommended information outputter according to this embodiment.

### Example Configuration of Drum Set

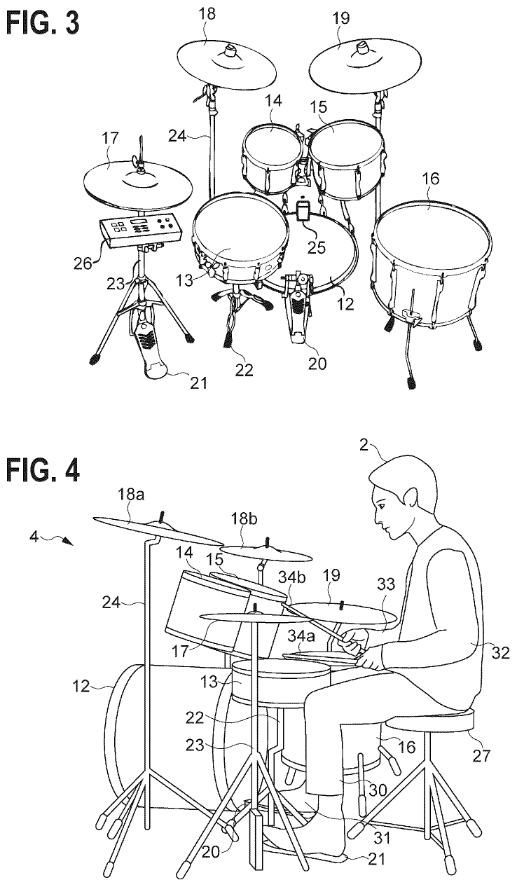

FIG. 3 is a schematic illustration of an example configuration of the drum set 4. The drum set 4 illustrated in FIG. 3 is also referred to as acoustic drums.

The following description of this embodiment takes the drum set 4 as an example of the drumming instrument 3. This embodiment described below is also applicable to any other form of the drumming instrument 3 than the drum set 4.

The drum set 4 illustrated in FIG. 3 includes a bass drum 12, a snare drum 13, a high tom 14, a low tom 15, a floor tom 16, hi-hat cymbals 17, a crash cymbal 18, and a ride cymbal 19.

The drum set 4 also includes a kick pedal (foot pedal) 20, a hi-hat pedal 21, a snare stand 22, a hi-hat stand 23, a cymbal stand 24, a sound acquisition device 25, and a control device 26. The hi-hat pedal 21 and the hi-hat stand 23 are integrally formed.

The drum set 4 also includes a chair 27 (see, for example, FIG. 4). The chair 27 is for the performer 2 to sit on. The drum set 4 also includes elements illustrated without reference numeral, such as: legs to support the floor tom 16; and tom holders to support the high tom 14 and the low tom 15 and mounted on the bass drum 12.

The sound acquisition device 25 obtains a sound produced by the drum set 4 by performing sound acquisition processing, and outputs a sound signal based on the obtained sound.

The control device 26 is connected to the sound acquisition device 25 wirelessly or via a wire. The control device 26 adds a sound effect to the sound signal output from the sound acquisition device 25, and outputs the resulting sound signal.

The performer 2 uses a sound emission device such as a headphone to listen to the sound signal output from the control device 26. Thus, the performer 2 listens to a sound produced by the performance of the performer 2.

There is no limitation to the configuration of the drum set 4 to which this embodiment is applicable; the drum set 4 with any configuration may be used.

For example, the configuration of the drum set 4 illustrated in FIG. 3 is typically set up for right-handed use, taking a right-handed performer 2 into consideration. In contrast, for a left-handed performer 2, there may be a case that the settings for the right-handed configuration illustrated in FIG. 3 are changed so that the drum set 4 is rearranged bilaterally symmetrically.

The following description assumes the example in which the performer 2 is right-handed and the drum set 4 is subjected to right-handed use settings. The following description is applicable to left-handed use settings by reversing the directions (left and right) mentioned in the description.

### Body State of Performer 2 (Posture of Performer 2 During Performance)

FIGS. 4 to 6 each are a schematic illustration of a body state of the performer 2 playing the drum set 4. By referring to FIGS. 4 to 6, postures of the body of the performer 2 playing the drum set 4 will be described.

The drum set 4 illustrated in FIGS. 4 to 6 has a configuration slightly different from the configuration of the drum set 4 illustrated in FIG. 3. Specifically, the drum set 4 illustrated in FIGS. 4 to 6 is not provided with the sound acquisition device 25 and the control device 26 illustrated in FIG. 3.

Also in the drum set 4 illustrated in FIGS. 4 to 6, two crash cymbals 18a and 18b are provided. The left crash cymbal 18a is provided at a position approximately identical to the position of the crash cymbal 18 illustrated in FIG. 3. The right crash cymbal 18b is provided at a position approximately identical to the position of the ride cymbal 19 illustrated in FIG. 3.

In the drum set 4 illustrated in FIGS. 4 to 6, the ride cymbal 19 is provided at a position between the low tom 15 and the floor tom 16.

In the examples illustrated in FIGS. 4 to 6, the performer 2 is seated on the chair 27 while playing the drum set 4.

The performer 2's right leg 31 rests on the kick pedal 20. With a motion of stepping on the kick pedal 20 with the right leg 31, the performer 2 is able to play the bass drum 12.

The performer 2's left leg 30 rests on the hi-hat pedal 21. With a motion of stepping on the hi-hat pedal 21 with the left leg 30, the performer 2 is able to control the opening and closing of the hi-hat cymbals 17.

The performer 2 is holding a drumstick 34a in the performer 2's left hand 32, and holding a drumstick 34b in the performer 2's right hand 33.

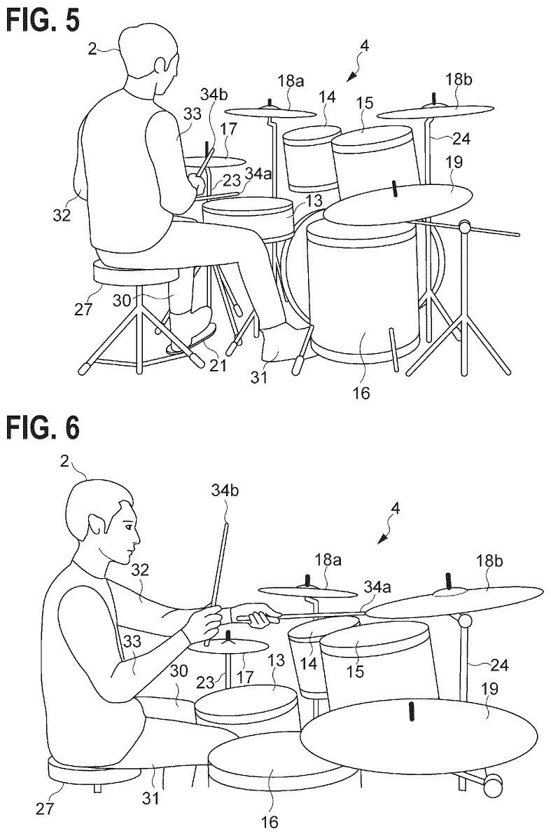

In the examples illustrated in FIGS. 4 and 5, the performer 2 plays the snare drum 13 using the drumstick 34a in the left hand 32. The performer 2 also plays the hi-hat cymbals 17 using the drumstick 34b in the right hand 33 with the right hand 33 crossing over the left hand 32.

The performer 2 moves each of the right leg 31, the left hand 32, and the right hand 33 to respectively play the bass drum 12, the snare drum 13, and the hi-hat cymbals 17, producing sounds at various timings to maintain various rhythms of 8 beats and 16 beats.

The performer 2 also operates the hi-hat pedal 21 with the left leg 30 in a manner deemed appropriate to control the opening and closing of the hi-hat cymbals 17. In this manner, the performer 2 is able to adjust the tone, length, and other features of the sound produced by the hi-hat cymbals 17. It will be readily appreciated that sound can be produced by opening and closing the hi-hat cymbals 17 when the performer 2 steps on the hi-hat pedal 21 with the left leg 30.

As illustrated in FIG. 6, the performer 2 moves the left hand 32 and the right hand 33 to strike the high tom 14, the low tom 15, the floor tom 16, the crash cymbals 18a and 18b, and the ride cymbal 19 with the drumsticks 34a and 34b. In this manner, the performer 2 is able to play each part of the drum set 4 to produce a sound unique to the each part.

By striking the drums and cymbals included in the drum set 4, the performer 2 is able to create various rhythms and various patterns.

In the present disclosure, each of the left leg 30 and the right leg 31 is intended to mean a part of the performer 2's body ranging from the uppermost part of each leg to the toetip of each foot. Also in the present disclosure, each of the left hand 32 and the right hand 33 is intended to mean a part of the performer 2's body ranging from the shoulder of each arm to the fingertip of each hand.

In some portions of the following description, parts of the body of the performer 2 are described in detail. In this context, terms such as thigh (femoral region), ankle, and knee are used where necessary to specify the intended part of the left leg 30 or the right leg 31; and terms such as wrist, forearm, elbow, and upper arm are used where necessary to specify the intended part of the left hand 32 or the right hand 33. The following description also includes a reference to other body parts than the upper and lower limbs. In this context, terms that facilitate understanding of the intended part are used where necessary.

There are various techniques and styles for playing the drum set 4. An example style is that the performer 2 keeps standing while playing the drum set 4, instead of sitting on the chair 27. An example technique is that the performer 2 plays the drum set 4 without the right hand 33 crossing over the left hand 32; specifically, the performer 2 performs open-handed playing, in which the performer 2 plays the hi-hat cymbals 17 with the left hand 32 and plays the snare drum 13 with the right hand 33.

There also are various techniques for holding the drumsticks 34a and 34b, such as matched grip and regular grip (traditional grip). In this respect, the way the performer 2 uses the performer 2's body to strike the snare drum 13, the toms, the cymbals varies depending on depending on the grip technique used.

Additionally, there are various types for the drumsticks 34a and 34b, including typical drumsticks, rods, brushes, broomsticks, and mallets. In this respect, the way the performer 2 uses the performer 2's body to strike the snare drum 13, the toms, the cymbals musical varies depending on the type of the drumstick used.

For example, in a case that the performer 2 uses a brush, the way the performer 2 uses the performer 2's arms differs from a case that the performer 2 uses a typical drumstick. In light of this fact, common practice is to increase the height of the snare stand 22 to set the hitting surface of the snare drum 13 to a higher position.

The drum setting assistance system 1 according to this embodiment is not limited to the drum set 4's specific forms, playing techniques, and drumstick types, and provides extensive assistance with the setting of the drum set 4.

Assistance with Drum Setting

The drum setting assistance system 1 outputs recommended information regarding the setting of the drum set 4 as played by the performer 2 based on information indicating the configuration of the drum set 4 and physical characteristics of the performer 2.

The output recommended information is recommended information corresponding to the body of the performer 2. That is, the drum setting assistance system 1 outputs recommended information optimized for each performer 2's body.

As described above by referring to FIGS. 1 and 2, to output the recommended information corresponding to the performer 2, the first obtainer 7 obtains configuration information and body information. In a case that the drumming instrument 3 is the drum set 4, the first obtainer 7 obtains: configuration information regarding the configuration of the drum set 4; and body information regarding the body of the performer 2 playing the drum set 4.

### Example of Configuration Information

The configuration information obtained by the first obtainer 7 includes information indicating what configuration the drum set 4 has.

An example of information that can be used as the configuration information is information indicating the current setting (physical setting) of the drum set 4 to be played. It is to be noted, however, that the current setting may not necessarily be included in the information in a case that the configuration of the drum set 4 to be played can be identified from the information.

For example, information that can be obtained as the configuration information may specify the model number of the drum set 4 from a predetermined manufacturer, and indicate the current setting of the drum set 4. This configuration, however, is not intended in a limiting sense. Another possible example that can be obtained as the configuration information may only specify the model number of the drum set 4 from a predetermined manufacturer.

Information examples that can be used as the configuration information will be enumerated below. It is to be noted that the information examples enumerated below are provided for illustrative purposes only and are not intended as limiting the configuration information.

### Captured Image Including Configuration of Drum Set 4

Examples that can be obtained and used as the configuration information include: the performance scene image 9 illustrated in FIG. 1; and a captured image showing only the drum set 4.

This captured image may not necessarily show the entirety of the drum set 4; a captured image showing only part of the drum set 4 may be acceptable in some cases. extracted information Extracted from Captured Image Including Configuration of Drum Set 4

Another example that can be obtained and used as the configuration information is extracted information regarding the configuration of the drum set 4. The extracted information is extracted from a captured image including the configuration of the drum set 4.

Examples of such extracted information include the following information.

Product information of the drum set 4 (such as type, name, manufacturer, and model number).

The quantity of each part of the drum set 4 and the arrangement of each part.

Information representing the foregoing examples may include “one tom, one floor tom” or “two toms, two floor toms”. Another example of the extracted information may include basic configuration such as the quantity of cymbals and the arrangement of the cymbals.

The position of each part of the drum set 4 may be calculated based on a predetermined coordinate system. There is no limitation to how to set this coordinate system; any method of setting may be used.

The size of each part of the drum set 4 (such as the diameter of each drum, and the size of each cymbal).

The configuration of each stand (such as model number and type).

The configuration of each holder (such as model number and type).

For example, the performer 2 inputs a captured image including the configuration of the drum set 4 (such as the performance scene image 9). From the captured image, the first obtainer 7 obtains an extracted image such as the above-described extracted image. The first obtainer 7 obtains this extracted image as the configuration information.

There is no limitation to how to extract the extracted information from the captured image; any technique (algorithm) may be used.

For example, any image recognition technique may be used such as image size conversion, character recognition, shape recognition, matching processing using a model image of an object, edge detection, and projective transformation. Another possible example is to query a database that stores information regarding the drum set 4 to obtain the extracted information. Another possible example is to utilize an externally built library having existing functions such as image processing and machine learning.

To extract the extracted information, any machine learning algorithm may be used. For example, by applying semantic segmentation to image information, the object type can be determined for each pixel of the image.

For example, it is possible to identify information regarding each part of the drum set 4, such as manufacturer and size, based on logo or text information included in the captured image.

There also may be a case that an object whose size is already known is identifiable in the captured image. In this case, it is possible to perform processing such as image size conversion with the size of this object used as a basis for scaling. This ensures that the size of another object in the captured image can be calculated.

For example, the lengths of the drumsticks 34a and 34b are typically standardized within a specific range. In light of this fact, it is possible to calculate the size of each part of the drum set 4 with the lengths of the drumsticks 34a and 34b in the captured image used as a basis for scaling.

Another possible example is that the size of the control device 26 illustrated in FIG. 1 is used as a basis for scaling. There may be a case that the size of the snare drum 13 is identifiable in the captured image by processing such as shape recognition. In this case, the snare drum 13 may be used as a basis for scaling.

It is also possible to perform feature point extraction to extract a feature point from each part of the drum set 4. In this case, it is possible to obtain configuration information regarding the configuration of the drum set 4 based on the extracted feature point. For example, it is possible to use information such as the position of the extracted feature point, the movement (momentum) of the extracted feature point, the speed of the extracted feature point, and the acceleration of the extracted feature point.

Input Information Input from Performer 2 and Regarding Configuration of Drum Set 4

For example, input information input from the performer 2 and regarding the configuration of the drum set 4 may be used as the configuration information.

For example, the product information of the drum set 4 exemplified above as the extracted information may be input directly by the performer 2; namely, the quantity of each part of the drum set 4 and the arrangement of each part, the size of each part of the drum set 4, the configuration of each stand, and the configuration of each holder.

There is no limitation to the method and GUI for the performer 2 to input the input information; the method and GUI may be designed in any manner deemed desirable. For example, text information such as “Please input basic configuration of the drum set” may be displayed together with selectable GUI items indicating basic configurations such as “One tom, one floor tom”, “Two crash cymbals”, and “One ride cymbal”. Thus, the performer 2 is able to select from the basic configurations.

Another possible example is that information such as product information of the drum set 4 is selectable from a pull-down menu.

It will be readily appreciated that the quantity and the size of each part of the drum set 4 (such as each drum and each cymbal) may be directly input in the form of text data. Another possible example is that information is inputtable interactively using sound, for example.

### Example of Body Information

The body information obtained by the first obtainer 7 includes information indicating physical characteristics of the performer 2. A typical example is that body build information indicating the body build of the performer 2 is used as the body information. This example, however, is not intended in a limiting sense.

Information examples that can be used as the body information will be enumerated below. It is to be noted that the information examples enumerated below are provided for illustrative purposes only and are not intended as limiting the body information.

### Captured Image Including Body of Performer 2

For example, the performance scene image 9 illustrated in FIG. 1 or a captured image showing only the body of the performer 2 can be obtained and used as the body information.

The captured image showing the entirety of the body of the performer 2 is not intended in a limiting sense; there may be a case that a captured image showing only part of the body of the performer 2 can be used.

Extracted Information Extracted from Captured Image Including Body of Performer 2

extracted information extracted from a captured image including the body of the performer 2 and regarding the body of the performer 2 can be obtained and used as the body information.

Examples of such extracted information include the following information.

Frame information indicating a body frame of the performer 2.

The frame information includes, for example, the position and the size of each part of the body of the performer 2. The following information may also be extracted as the frame information: height; length of the upper half of the body; length of the lower half of the body; lengths of the four limbs (the left leg 30, the right leg 31, the left hand 32, and the right hand 33), palm size, forearm length (from the wrist to the elbow), upper arm length (from the elbow to the shoulder), neck length, thigh length (from the uppermost part of the leg to the knee), shin length (from the knee to the ankle), and foot size.

The position of each part of the body may be calculated based on a predetermined coordinate system. There is no limitation to how to set this coordinate system; any method of setting may be used.

The posture of the performer 2 (such as the position and inclination of each part).

The center of gravity of the performer 2 and displacement state of the center of gravity.

The movement of the performer 2 (displacement state of the position of each part).

These pieces of information are often obtainable as the frame information of the performer 2.

The size, position, and movement of the drumsticks 34a and 34b.

The distance from the shoulder to the tip of the drumstick (distance from the shoulder at the left hand 32 to the tip of the drumstick 34a/distance from the shoulder at the right hand 33 to the tip of the drumstick 34b).

It is to be noted that the drumsticks 34a and 34b are held by the performer 2. Therefore, information regarding the drumsticks 34a and 34b can be used as the body information. In contrast, the information regarding the drumsticks 34a and 34b may also be used as the configuration information regarding the configuration of the drum set 4.

For example, the performer 2 inputs a captured image including the body of the performer 2 (such as the performance scene image 9). From the captured image, the first obtainer 7 extracts the above-described extracted image and obtains the extracted image as the body information.

There is no limitation to the method of extracting extracted information from the captured image; any technique (algorithm) may be used.

It is possible to use any image recognition technique such as image size conversion, character recognition, shape recognition, matching processing using a model image of a human body, edge detection, and projective transformation. It is also possible to apply frame estimation (bone estimation). Another possible example is to query a database storing human body information to obtain the extracted information. Another possible example is to utilize an externally built library having existing functions such as image processing and machine learning.

To extract the extracted information, any machine learning algorithm may be used. For example, by applying semantic segmentation to image information, the body part type can be determined for each pixel of the image.

There also may be a case that an object whose size is already known is identifiable in the captured image. In this case, it is possible to perform processing such as image size conversion with the size of this object used as a basis for scaling. This ensures that the size of each part of the body of the performer 2 in the captured image can be calculated.

For example, it is possible to calculate the size of each part of the body of the performer 2 with the lengths of the drumsticks 34a and 34b in the captured image used as a basis for scaling.

It is also possible to use the size of any other object as a basis for scaling. For example, there may be a case that the size of the snare drum 13 is identifiable in the captured image by processing such as shape recognition. In this case, the snare drum 13 may be used as a basis for scaling.

It is also possible to perform feature point extraction to extract a feature point from each part of the body of the performer 2. In this case, it is possible to obtain body information regarding the body of the performer 2 based on the extracted feature point. For example, it is possible to use information such as the position of the extracted feature point, the movement (momentum) of the extracted feature point, the speed of the extracted feature point, and the acceleration of the extracted feature point.

Input Information Input from Performer 2 and Regarding Body of Performer 2

For example, input information input from the performer 2 and regarding the body of the performer 2 may be used as the body information.

For example, the above-described extracted information may be input directly by the performer 2, such as the frame information of the performer 2 (information that the performer 2 is able to input, such as height) and the lengths of the drumsticks 34a and 34b.

There is no limitation to the method and GUI for the performer 2 to input the input information; the method and GUI may be designed in any manner deemed desirable. For example, text information such as “Please input height” may be displayed together with a pull-down menu from which height is selectable. It will be readily appreciated that the size of each part of the body of the performer 2, such as height, may be directly input in the form of text data. Another possible example is that information is inputtable interactively using sound, for example.

For example, there may be a case that a captured image, such as the performance scene image 9, includes both the drum set 4 and the body of the performer 2. In this case, the first obtainer 7 obtains this captured image as information that includes both the configuration information and the body information.

Another possible example is that the first obtainer 7 obtains a combination of the above-described configuration information and body information. For example, any combination of at least one piece of the above-described configuration information and at least one piece of the above-described body information may be obtained and used.

There also may be a case that a plurality of pieces of configuration information and a plurality of pieces of body information are obtained.

For example, the performer 2 may input a captured image including only the configuration of the drum set 4 and a captured image including only the body of the performer 2.

The first obtainer 7 obtains these captured images as the configuration information and the body information. Another possible example is that at least one piece of extracted information is extracted from these captured images and obtained by the first obtainer 7 as the configuration information and the body information.

Another possible example is that no captured image is input by the performer 2. For example, input information regarding the configuration of the drum set 4 and input information regarding the body of the performer 2 are input from the performer 2 via a predetermined GUI. These pieces of input information may be obtained and used as the configuration information and the body information.

### Recommended Information

recommended information is output by the recommended information outputter 8, and includes recommended configuration information and recommended body information.

The recommended configuration information is recommended information regarding a recommended configuration of the drumming instrument 3 for the body of the performer 2 in playing the drumming instrument 3. In this embodiment, recommended information regarding a recommended configuration of the drum set 4 for the body of the performer 2 in playing the drum set 4 is output as the recommended configuration information.

The recommended body information is recommended information regarding a recommended posture of the body of the performer 2 in playing the drumming instrument 3. In this embodiment, recommended information regarding a recommended posture of the body of the performer 2 in playing the drum set 4 is output as the recommended body information.

### Recommended Configuration Information

The recommended configuration information is information corresponding to the body of the performer 2. Examples of this information include the position of each part of the drumming instrument 3, the height of each part of the drumming instrument 3, the posture of each part of the drumming instrument 3, and a positional relationship between the parts of the drumming instrument 3. At least one of these pieces of information may be output.

The position of each part of the drumming instrument 3 is a position on the installation surface (ground) on which the drumming instrument 3 is installed.

The height of each part of the drumming instrument 3 is a height (distance) from the installation surface.

The posture of each part of the drumming instrument 3 is an angle relative to the installation surface, and can also be referred to as an inclination relative to the installation surface. Typically, the posture of each part of the drumming instrument 3 is an angle relative to a horizontal plane (inclination relative to a horizontal plane).

Examples of the positional relationship between the parts of include the distance between two or more parts and the angle defined between two or more parts.

In this embodiment, information regarding the position of each part of the drum set 4, the height of each part of the drum set 4, the posture (including inclination) of each part of the drum set 4, and a positional relationship between the parts of the drum set 4 is output as the recommended configuration information. Another possible example is that information regarding the position of each part of the drum set 4, the height of each part of the drum set 4, the posture (including inclination) of each part of the drum set 4, or a positional relationship between the parts of the drum set 4 is output as the recommended configuration information.

For example, information indicating which parts of the drum set 4 need to be moved, the manner in which the parts of the drum set 4 should be moved, and the degree to which the parts of the drum set 4 should be moved may be output as the recommended configuration.

There may be a case that the position of each part of the drum set 4, the height of each part of the drum set 4, the posture (including inclination) of each part of the drum set 4, and a positional relationship between the parts of the drum set 4 are specified by manufacturer standard values (each standard will be hereinafter referred to as standard configuration). In this case, a difference between each of the foregoing parameters and the corresponding standard configuration may be output as the recommended configuration information.

In the following description, examples of the recommended configuration information will be enumerated. It is to be noted that the information examples enumerated below are provided for illustrative purposes only and are not intended as limiting the recommended configuration information.

### Information Regarding Position and Height of Chair 27

Information indicating a request to adjust the position of the chair 27 or the height of the chair 27 may be output as the recommended configuration information.

Information recommended as the recommended configuration information regarding the position of the chair 27 may indicate adjustment of a positional relationship between the chair 27 and the bass drum 12 to a recommended state. Details of this information will be described later as information regarding the position of the bass drum 12.

A recommended state of the height of the chair 27 may be that when the performer 2 sits on the chair 27, the thighs of the performer 2 are parallel to a horizontal plane with the soles of the feet entirely touching the installation surface, or the thighs of the performer 2 are inclined relative to a horizontal plane with the knees slightly lower than the uppermost parts of the legs.

To realize this recommended state, information indicating a request to adjust the height of the chair 27 is output as the recommended configuration information. It is to be noted that the angle of the thighs of the performer 2 may be determined with a plane direction of the installation surface aligned with a horizontal direction or a plane direction of the seat surface of the chair 27 aligned with a horizontal direction.

For example, information indicating “Please raise the chair”, “Please lower the chair”, “Please raise the chair above the manufacturer standard value”, or “Please lower the chair below the manufacturer standard value” may be output as the recommended configuration information.

It will be readily appreciated that the recommended configuration information may be output in the form of specific values (such as in centimeters (cm)). For example, it is possible to specify a target value range for adjustment, such as “Please adjust the chair height between the range of from X cm to Y cm”, or pinpoint a predetermined value.

It is to be noted that the above-described recommended state of the height of the chair 27 is provided for illustrative purposes only and is not intended in a limiting sense. There can be various perspectives on what constitutes the recommended state for each performer, regarding the configuration of the drum set 4, such as the height of the chair 27. There may also be performers who personally prefer a state that is not generally recommended.

With these considerations in mind, a recommended state regarding the configuration of the drum set 4 may be adjustable through customization or another method. A possible example that can be set as a recommended state of the height of the chair 27 is that the thighs of the performer 2 are inclined relative to a horizontal plane with the knees of the performer 2 slightly higher than the uppermost parts of the legs. For any recommended state set arbitrarily in this manner, it is possible to generate recommended information to achieve the recommended state.

It is also possible to configure the initial settings so that a generally recommended state is set by default.

It is to be noted that this recommended state is not intended in a limiting sense; the same applies to recommended states regarding other configurations of the drum set 4, described below. The same also applies to a recommended state regarding the body of the performer 2 playing the drum set 4.

### Information Regarding Position and Inclination of Bass Drum 12

Information indicating a request to adjust the position and the inclination of the bass drum 12 may be output as the recommended configuration information.

Information recommended as the recommended configuration information regarding the position of the bass drum 12 may indicate adjustment of a positional relationship between the bass drum 12 and the chair 27 to a recommended state.

For example, the performer 2 sits on the chair 27 and places the right leg 31 on the kick pedal 20. In this case, a recommended state of the angle of the shin of the right leg 31 may be a state in which the bass drum 12 is positioned so that the ankle is positioned slightly further forward (closer to the bass drum 12) than the knee.

Another possible recommended state is that the bass drum 12 is positioned so that when viewed from above, the direction in which the thigh of the right leg 31 extends (direction from the uppermost part of the leg toward the knee) is orthogonal to the hitting surface of the bass drum 12.

To realize this recommended state, information indicating a request to adjust the position of the bass drum 12 is output as the recommended configuration information.

For example, information indicating “Please move the bass drum closer to the chair”, “Please move the bass drum away from the chair”, “Please increase the distance between the bass drum and the chair beyond the manufacturer standard value”, or “Please decrease the distance between the bass drum and the chair below the manufacturer standard value” may be output as the recommended configuration information. It will be readily appreciated that the recommended configuration information may be output in the form of specific values (such as in centimeters (cm)) to specify a predetermined value range or a

To realize the recommended state of the positional relationship between the bass drum 12 and the chair 27, it is possible to output recommended configuration information regarding the position of the chair 27. For example, information indicating “Please move the chair closer to the bass drum” or “Please move the chair away from the bass drum” may be output as the recommended configuration information.

Thus, for a positional relationship between two parts, it is possible to output recommended configuration information that enables adjustment the position of each part to realize the recommended state. It is to be noted that information indicating a more direct request to adjust the positional relationship between two parts may be output as the recommended configuration information, such as “Please increase the distance between the chair and the bass drum”, and “Please decrease the distance between the chair and the bass drum” (this will be described later).

Regarding the inclination of the bass drum 12, a possible state that can be set as the recommended state is that the front edge of the bass drum 12 (edge opposite to the hitting surface) is slightly raised above the installation surface. This recommended state has the effect of improving the sound quality of the bass drum 12 rather than making the bass drum 12 easier to play.

To realize this recommended state, information indicating a request to adjust the height (the amount of raising) of the front edge of the bass drum 12 is output as the recommended configuration information.

For example, information indicating “Please slightly raise the front edge of the bass drum above the ground” or “Please increase the height of the front edge of the bass drum beyond the manufacturer standard value” may be output as the recommended configuration information. It will be readily appreciated that the recommended configuration information may be output in the form of specific values (such as in centimeters (cm)) to specify a predetermined value range or a predetermined value.

For example, it is possible to calculate the amount of raising based on the depth of the bass drum 12 (which is the size between the hitting surface and the front surface). For example, for a depth of 16 inches, the amount of raising may be 10 mm. It is also possible to instruct an inclination-related recommended state using an angle.

Information regarding Position, Height, and Inclination of Snare Drum 13

Information indicating a request to adjust the position, the height, and the inclination of the snare drum 13 may be output as the recommended configuration information.

Regarding the position of the snare drum 13, for example, the performer 2 sits on the chair 27 and places the right leg 31 on the kick pedal 20. In this case, a possible recommended state that can be set is that the snare drum 13 positioned in front of the body of the performer 2. For example, a possible state that can be set as the recommended state is that when viewed from above, a center of the snare drum 13 is provided on a center axis extending forward from a center of the body of the performer 2.

There also may be a case that the performer 2 is poised with the tips of the drumsticks 34a and 34b aimed at the center of the snare drum 13. In this case, a possible state that can be set as the recommended state is that the snare drum 13 is positioned so that the upper arms of the performer 2 extend vertically downward beside the body of the performer 2. In this case, a non-recommended state is that the snare drum 13 is positioned with the elbows of the performer 2 held too far from the body of the performer 2.

To realize this recommended state, information indicating a request to adjust the position of the snare drum 13 is output as the recommended configuration information.

For example, information indicating “Please move the snare drum closer to the chair”, “Please move the snare drum away from the chair”, “Please increase the distance between the snare drum and the chair beyond the manufacturer standard value”, or “Please decrease the distance between the snare drum and the chair below the manufacturer standard value” may be output as the recommended configuration information. It will be readily appreciated that the recommended configuration information may be output in the form of specific values (such as in centimeters (cm)) to specify a predetermined value range or a

Regarding the height of the snare drum 13, for example, the performer 2 is poised with the tips of the drumsticks 34a and 34b aimed at the center of the snare drum 13. In this case, a possible state that can be set as the recommended state is that the height of the hitting surface of the snare drum 13 is included within the range between the height of the knees of the performer 2 and the height of the elbows of the performer 2. It is to be noted that a range serving as a recommended state can also be referred to as a recommended range.

A more specific state that can be set as the recommended state is that the height of the hitting surface of the snare drum 13 is slightly lower than the height of a navel (belly button) of the performer 2.

To realize this recommended state, information indicating a request to adjust the height of the snare drum 13 is output as the recommended configuration information.

For example, information indicating “Please decrease the height of the snare drum”, “Please increase the height of the snare drum”, “Please decrease the height of the snare drum below the manufacturer standard value”, or “Please increase the height of the snare drum beyond the manufacturer standard value” may be output as the recommended configuration information. It will be readily appreciated that the recommended configuration information may be output in the form of specific values (such as in centimeters (cm)) to specify a predetermined value range or a predetermined value.

Regarding the inclination of the snare drum 13, a possible state that can be set as the recommended state is that when viewed from above, the hitting surface of the snare drum 13 is slightly inclined toward the center of the body of the performer 2, that is, toward the performer 2 himself/herself. In this case, a non-recommended state is that the snare drum 13 is inclined toward the far side from the performer 2 (away from the body of the performer 2).

Regarding the inclination of the snare drum 13, many performers prefer to set the hitting surface horizontally for a more visually appealing (cool) presentation during performances. With this consideration in mind, a horizontal state may also be set as the recommended state. It is also possible to set a specific angle range as the recommended state.

To realize this recommended state, information indicating a request to adjust the inclination of the snare drum 13 is output as the recommended configuration information.

For example, information indicating “Please incline the snare drum toward the performer” may be output as the recommended configuration information. It will be readily appreciated that the recommended configuration information may be output in the form of specific values (such as in centimeters (cm)) to specify a predetermined value range or a predetermined value.

### Information Regarding Position and Height of Hi-Hat Cymbals 17

Information indicating a request to adjust the position and the height of the hi-hat cymbals 17 may be output as the recommended configuration information. The position of the hi-hat cymbals 17 can also be referred to as the position of the hi-hat stand 23.

Regarding the position of the hi-hat cymbals 17, for example, the performer 2 sits on the chair 27 and places the left leg 30 on the hi-hat pedal 21. In this case, a possible recommended state of the angle of the shin of the left leg 30 is that the hi-hat cymbals 17 are positioned so that the ankle is positioned slightly further forward (closer to the hi-hat cymbals 17) than the knee.

Another possible state that can be set as the recommended state is that when viewed from above, a center of the hi-hat cymbals 17 is located on an axis extending along the direction in which the thigh of the left leg 30 extends (direction from the uppermost part of the leg toward the knee). To realize this recommended state, information indicating a request to adjust the position of the hi-hat cymbals 17 is output as the recommended configuration information.

For example, information indicating “Please move the hi-hat cymbal (hi-hat stand) closer to the chair”, “Please move the hi-hat cymbal (hi-hat stand) away from the chair”, “Please increase the distance between the hi-hat cymbal (hi-hat stand) and the chair beyond the manufacturer standard value”, or “Please decrease the distance between the hi-hat cymbal (hi-hat stand) and the chair below the manufacturer standard value” may be output as the recommended configuration information. It will be readily appreciated that the recommended configuration information may be output in the form of specific values (such as in centimeters (cm)) to specify a predetermined value range or a predetermined value.

Regarding the height of the hi-hat cymbals 17, a possible state that can be set as the recommended state is that the difference between the height of the hi-hat cymbals 17 and the height of the hitting surface of the snare drum 13 is included within a predetermined range. For example, a state that can be set as the recommended state is that the hi-hat cymbals 17 are positioned 20 cm to 25 cm above the hitting surface of the snare drum 13.

To realize this recommended state, information indicating a request to adjust the height of the hi-hat cymbals 17 is output as the recommended configuration information.

For example, information indicating “Please decrease the height of the hi-hat cymbal”, “Please increase the height of the hi-hat cymbal”, “Please decrease the height of the hi-hat cymbal below the manufacturer standard value”, or “Please increase the height of the hi-hat cymbal beyond the manufacturer standard value” may be output as the recommended configuration information. It will be readily appreciated that the recommended configuration information may be output in the form of specific values (such as in centimeters (cm)) to specify a predetermined value range or a predetermined value.

It is to be noted that there is considerable individual variation in the difference between the height of the hi-hat cymbals 17 and the height of the snare drum 13. Such individual variation can be accommodated by adjusting the specific values within the difference range (recommended range) set as the recommended state to fit individual needs.

### Information Regarding Position, Height, and Inclination of Floor Tom 16

Information indicating a request to adjust the position, the height, and the inclination of the floor tom 16 may be output as the recommended configuration information.

Regarding the position of the floor tom 16, a possible state that can be set as the recommended state is that a center of the hitting surface of the snare drum 13 and a center of the hitting surface of the floor tom 16 are approximately bilaterally symmetric relative to an axis extending in a direction perpendicular to a center of the hitting surface of the bass drum 12.

To realize this recommended state, information indicating a request to adjust the position of the floor tom 16 is output as the recommended configuration information.

For example, information indicating “Please move the position of the floor tom closer to the bass drum”, “Please arrange the floor tom at an approximately symmetric position with the snare drum relative to the bass drum”, or “Please displace the position of the floor tom to the right beyond the manufacturer standard value” may be output as the recommended configuration information. It will be readily appreciated that the recommended configuration information may be output in the form of specific values (such as in centimeters (cm)) to specify a predetermined value range or a predetermined value.

It is to be noted that there is considerable individual variation in what constitutes a preferable state for striking the floor tom 16. Such individual variation can be accommodated by setting the recommended state to fit individual needs.

Regarding the height of the floor tom 16, a possible state that can be set as the recommended state is that the height of the floor tom 16 (the height of the hitting surface) is approximately identical to the height of the snare drum 13 (the height of the hitting surface). That is, a state in which the height of the floor tom 16 and the height of the snare drum 13 are aligned can be set as the recommended information.

To realize this recommended state, information indicating a request to adjust the height of the floor tom 16 is output as the recommended configuration information.

For example, information indicating “Please decrease the height of the floor tom”, “Please increase the height of the floor tom”, “Please decrease the height of the floor tom below the manufacturer standard value”, or “Please increase the height of the floor tom beyond the manufacturer standard value” may be output as the recommended configuration information. It will be readily appreciated that the recommended configuration information may be output in the form of specific values (such as in centimeters (cm)) to specify a predetermined value range or a predetermined value.

Regarding the inclination of the floor tom 16, a possible state that can be set as the recommended state is that when viewed from above, the hitting surface of the floor tom 16 is slightly inclined toward the center of the body of the performer 2, that is, toward the performer 2 himself/herself. In this case, a non-recommended state is that the floor tom 16 is inclined toward the far side from the performer 2 (away from the body of the performer 2).

To realize this recommended state, information indicating a request to adjust the inclination of the floor tom 16 is output as the recommended configuration information.

For example, information indicating “Please incline the floor tom toward the performer” may be output as the recommended configuration information. It will be readily appreciated that the recommended configuration information may be output in the form of specific values (such as in centimeters (cm)) to specify a predetermined value range or a predetermined value.

### Information Regarding Position, Height, and Inclination of Tom

Information indicating a request to adjust the position, the height, and the inclination of the tom (which is a term encompassing the high tom 14 and the low tom 15) may be output as the recommended configuration information.

Regarding the position and the height of the tom, the performer 2 is poised with the tips of the drumsticks 34a and 34b aimed at a center of the tom. In this case, a possible state that can be set as the recommended state is that the tom is positioned so that the left hand 32 and the right hand 33 (the arms) are not fully stretched, that is, the elbows are slightly bent, allowing for additional movement or flexibility. Another possible state that can be set as the recommended state is that the tom is positioned for easy access by the performer 2. To realize this recommended state, information indicating a request to adjust the position and the height of the tom is output as the recommended configuration information.

For example, information indicating “Please increase the height of the high tom”, “Please move the position of the low tom forward”, or “Please decrease the height of the high tom below the manufacturer standard value” may be output as the recommended configuration information. It will be readily appreciated that the recommended configuration information may be output in the form of specific values (such as in centimeters (cm)) to specify a predetermined value range or a predetermined value.

Regarding the inclination of the tom (which is a term encompassing the high tom 14 and the low tom 15), a possible state that can be set as the recommended state is that when viewed from above, the hitting surface of the tom is slightly inclined toward the center of the body of the performer 2, that is, toward the performer 2 himself/herself. In this case, a non-recommended state is that the tom is inclined toward the far side from the performer 2 (away from the body of the performer 2).

To realize this recommended state, information indicating a request to adjust the inclination of the tom is output as the recommended configuration information.

For example, information indicating “Please incline the tom toward the performer” may be output as the recommended configuration information. It will be readily appreciated that the recommended configuration information may be output in the form of specific values (such as in centimeters (cm)) to specify a predetermined value range or a predetermined value.

### Information Regarding Position, Height, and Inclination of Cymbal

Information indicating a request to adjust the position, the height, and the inclination of the cymbal (which is a term encompassing the crash cymbal 18 and the ride cymbal 19) may be output as the recommended configuration information.

Regarding the position and the height of the cymbal, a possible state that can be set as the recommended state is that the height of the crash cymbal 18 is included within the range between the height of the shoulder of the performer 2 and the height of the drummer's eye level. Another possible state that can be set as the recommended state is that the height of the ride cymbal 19 is approximately equal to the height of the hi-hat cymbals 17.

Another possible state that can be set as the recommended state is that the cymbals are placed at positions and heights that are easy for performer 2 to strike. It is to be noted that there is considerable individual variation in the optimal position and height for striking each cymbal. Such individual variation can be accommodated by adjusting the specific values within the recommended range set as the recommended state to fit individual needs.

To realize this recommended state, information indicating a request to adjust the position and the height of the cymbal is output as the recommended configuration information.

For example, information indicating “Please increase the height of the crash cymbal”, “Please move the position of the ride cymbal toward the performer”, or “Please decrease the height of the crash cymbal below the manufacturer standard value” may be output as the recommended configuration information. It will be readily appreciated that the recommended configuration information may be output in the form of specific values (such as in centimeters (cm)) to specify a predetermined value range or a predetermined value.

Regarding the inclination of the cymbal, a possible state that can be set as the recommended state is that when viewed from above, the cymbal is slightly inclined toward the center of the body of the performer 2, that is, toward the performer 2 himself/herself. In this case, a non-recommended state is that the cymbal is inclined toward the far side from the performer 2 (away from the body of the performer 2).

To realize this recommended state, information indicating a request to adjust the inclination of the cymbal is output as the recommended configuration information.

For example, information indicating “Please incline the crash cymbal toward the performer” may be output as the recommended configuration information. It will be readily appreciated that the recommended configuration information may be output in the form of specific values (such as in centimeters (cm)) to specify a predetermined value range or a predetermined value.

### Information Regarding Height Difference Between Snare Drum 13 and Hi-Hat Cymbals 17

Information indicating a request to adjust a positional relationship between two or more parts of the drum set 4 may be output as the recommended configuration information.

As described above, a possible recommended state regarding the height of the hi-hat cymbals 17 is that the difference between the height of the hi-hat cymbals 17 and the height of the hitting surface of the snare drum 13 is included within a predetermined range (for example, 20 cm to 25 cm).

This recommended state may be set as a recommended state regarding the height difference between the snare drum 13 and the hi-hat cymbals 17. In this case, it is possible to output recommended configuration information indicating a request to adjust the height difference between the snare drum 13 and the hi-hat cymbals 17 to the recommended state.

For example, information indicating “Please increase the distance between the hi-hat cymbal and the snare drum” or “Please decrease the distance between the hi-hat cymbal and the snare drum below the manufacturer standard value” may be output as the recommended configuration information. It will be readily appreciated that the recommended configuration information may be output in the form of specific values (such as in centimeters (cm)) to specify a predetermined value range or a predetermined value.

It is to be noted that the height difference between the snare drum 13 and the hi-hat cymbals 17 is not intended in a limiting sense; it is also possible to output recommended configuration information indicating a request to adjust the positional relationship between the high tom 14 and the low tom 15, the positional relationship between the ride cymbal 19 and the hi-hat cymbals 17, or the positional relationship between the snare drum 13 and the floor tom 16.

### Recommended Body Information

The recommended body information is information recommended for the performer 2 to play the drumming instrument 3. Specifically, the recommended body information includes the position of each part of the body of the performer 2, the height of each part of the body of the performer 2, the posture of each part of the body of the performer 2, and a positional relationship between the parts of the body of the performer 2. At least one of these pieces of information may be output.

The position of each part of the body of the performer 2 is a position on the installation surface (ground) on which the drumming instrument 3 is installed.

The height of each part of the body of the performer 2 is a height (distance) from the installation surface.

The posture of each part of the body of the performer 2 is an angle relative to the installation surface, and can also be referred to as an inclination relative to the installation surface. Typically, the posture of each part of the body of the performer 2 is an angle relative to a horizontal plane (inclination relative to a horizontal plane).

The positional relationship between the parts of the body of the performer 2 includes the distance between two or more parts and the angle defined by two or more parts crossing each other.

Possible information that can be output as the recommended body information is information indicating which part of the body of the performer 2 should assume which specific posture.

In the following description, examples of the recommended body information will be enumerated. It is to be noted that the information examples enumerated below are provided for illustrative purposes only and are not intended as limiting the recommended body information.

### Information Regarding Angle of Thigh of Performer 2 Sitting on Chair 27

Regarding the angle of each thigh of the performer 2 sitting on the chair 27, a possible state that can be set as the recommended state is that the thighs of the performer 2 are parallel to a horizontal plane with the soles of the feet entirely touching the installation surface, or the thighs of the performer 2 are inclined relative to a horizontal plane with the knees slightly lower than the uppermost parts of the legs.

Information guiding the angle of the thighs of the performer 2 to this recommended state is output as the recommended body information. It is to be noted that the angle of the thighs of the performer 2 may be determined with a plane direction of the installation surface aligned with a horizontal direction or a plane direction of the seat surface of the chair 27 aligned with a horizontal direction.

For example, information indicating “Please adjust the settings to position the thigh horizontally.” or “Please adjust the settings to position the knee slightly lower than the uppermost part of the leg” can be output as the recommended body information.

It is to be noted that the angle of the thighs of the performer 2 sitting on the chair 27 is correlated with the height of the chair 27. Specifically, the recommended state regarding the angle of the thighs of the performer 2 often corresponds to the recommended state regarding the height of the chair 27. More specifically, the recommended state regarding the angle of the thighs of the performer 2 is often identical to the recommended state regarding the height of the chair 27.

In light of this fact, there may be a case that the recommended body information regarding the angle of the thighs of the performer 2 sitting on the chair 27 corresponds to the recommended configuration information regarding the height of the chair 27. For example, information indicating “Please increase the height of the chair to position the thigh parallel to horizontal plane” may be included in both the recommended body information and the recommended configuration information. Thus, some recommended information is included in both the recommended body information and the recommended configuration information.

Information Regarding Positional Relationship between Bass Drum 12 and Leg Striking Bass Drum 12

Regarding the positional relationship between the bass drum 12 and the right leg 31 striking the bass drum 12, a possible state that can be set as the recommended state is that when viewed from above, the direction in which the thigh of the right leg 31 extends (direction from the uppermost part of the leg toward the knee) is orthogonal to the hitting surface of the bass drum 12.

Information guiding the positional relationship between the bass drum 12 and the leg striking the bass drum 12 to this recommended state is output as the recommended body information.

For example, information indicating “Please adjust the settings to position the thigh of the left leg orthogonal to the bass drum” can be output as the recommended body information.

There may be a case that the recommended body information regarding the positional relationship between the bass drum 12 and the leg striking the bass drum 12 corresponds to the recommended configuration information regarding the position of the bass drum 12. For example, information indicating “Please reorient the bass drum to position the thigh of the left leg orthogonal to the bass drum” may be output as recommended information included in both the recommended body information and the recommended configuration information.

### Information Regarding Angle of Shin of Leg Striking Bass Drum 12

For example, a possible recommended state of the angle of the shin of the right leg 31 striking the bass drum 12 is that when the performer 2 sits on the chair 27 and places the right leg 31 on the kick pedal 20, the ankle is positioned slightly further forward (closer to the bass drum 12) than the knee.

Information guiding the angle of the shin of the leg striking the bass drum 12 to this recommended state is output as the recommended body information.

For example, information indicating “Please adjust the settings to adjust the angle of the shin of the right leg 31 such that the ankle side is positioned slightly further forward” can be output as the recommended body information.

There may be a case that the recommended body information regarding the angle of the shin of the leg striking the bass drum 12 corresponds to the recommended configuration information regarding the position of the bass drum 12. For example, information indicating “Please move the bass drum away from the chair to position the ankle side of the left leg slightly further forward than the knee” may be output as recommended information included in both the recommended body information and the recommended configuration information.

Information Regarding Positional Relationship between Snare Drum 13 and Body of Performer 2

Regarding the positional relationship between the snare drum 13 and the body of the performer 2, for example, the performer 2 sits on the chair 27 and places the right leg 31 on the kick pedal 20. In this case, a possible recommended state that can be set is that the snare drum 13 is provided in front of the body of the performer 2.

Information guiding the positional relationship between the snare drum 13 and the body of the performer 2 to this recommended state is output as the recommended body information.

For example, information indicating “Please adjust the settings to position the body facing forward relative to the snare drum” can be output as the recommended body information.

There may be a case that the recommended body information regarding the positional relationship between the snare drum 13 and the body of the performer 2 corresponds to the recommended configuration information regarding the position of the snare drum 13. For example, information indicating “Please reorient the snare drum to position the body facing forward relative to the snare drum” may be output as recommended information included in both the recommended body information and the recommended configuration information.

### Information Regarding Positional Relationship Between Upper Arm and Body of Performer 2 Playing Snare Drum 13

For example, the performer 2 is poised with the tips of the drumsticks 34a and 34b aimed at the center of the snare drum 13. In this case, a possible state that can be set as the recommended state is that the upper arms of the performer 2 extend vertically downward beside the body of the performer 2. For example, a non-recommended state is that the elbows of the performer 2 are held too far from the body of the performer 2.

Information guiding the positional relationship between each upper arm and the body of the performer 2 playing the snare drum 13 to this recommended state is output as the recommended body information.

For example, information indicating “Please adjust the settings to keep the elbows close to the body when the performer 2 assumes a playing posture relative to the snare drum” can be output as the recommended body information.

There may be a case that the recommended body information regarding the positional relationship between the upper arm and the body of the performer 2 playing the snare drum 13 corresponds to the recommended configuration information regarding the position of the snare drum 13. For example, information indicating “Please position the snare drum so that the elbows are kept close to the body when the performer 2 assumes a playing posture relative to the snare drum” may be output as recommended information included in both the recommended body information and the recommended configuration information.

Information Regarding Height Relationship between Snare Drum 13, Elbow, and Knee

For example, the performer 2 is poised with the tips of the drumsticks 34a and 34b aimed at the center of the snare drum 13. In this case, a possible state that can be set as the recommended state is that the height of the hitting surface of the snare drum 13 is included with in the range between the height of the knees of the performer 2 and the height of the elbows of the performer 2.

A more specific state that can be set as the recommended state is that the height of a cross-section of the snare drum 13 is slightly lower than the height of the navel of the performer 2.

Information guiding the height relationship between the snare drum 13, the elbow, and the knee to this recommended state is output as the recommended body information.

For example, information indicating “Please adjust the settings to position the snare drum in the range between the height of the knee and the height of the elbow when the performer 2 assumes a playing posture relative to the snare drum” can be output as the recommended body information.

There may be a case that the recommended body information regarding the height relationship between the snare drum 13, the elbow, and the knee corresponds to the recommended configuration information regarding the height of the snare drum 13. For example, information indicating “Please increase the height of the snare drum to the range between the height of the knee and the height of the elbow when the performer 2 assumes a playing posture relative to the snare drum” may be output as recommended information included in both the recommended body information and the recommended configuration information.

### Information Regarding Positional Relationship Between Hi-Hat Cymbals 17 and Leg of Performer 2 Controlling Hi-Hat Cymbals 17

For example, the performer 2 sits on the chair 27 and places the left leg 30 on the hi-hat pedal 21. In this case, a possible state that can be set as the recommended state is that when viewed from above, the direction in which the thigh of the left leg 30 extends (direction from the uppermost part of the leg toward the knee) is pointed toward the center of the hi-hat cymbals 17.

Information guiding the positional relationship between the hi-hat cymbals 17 and the leg of the performer 2 controlling the hi-hat cymbals 17 to this recommended state is output as the recommended body information.

For example, information indicating “Please adjust the settings to stretch the thigh of the left leg toward the center of the hi-hat cymbals” can be output as the recommended body information.

There may be a case that the recommended body information regarding the positional relationship between the hi-hat cymbals 17 and the leg of the performer 2 controlling the hi-hat cymbals 17 corresponds to the recommended configuration information regarding the position of the hi-hat cymbals 17 (the hi-hat stand 23). For example, information indicating “Please reorient the hi-hat cymbals to stretch the thigh of the left leg toward the center of the hi-hat cymbals” may be output as recommended information included in both the recommended body information and the recommended configuration information.

### Information Regarding Angle of Shin of Leg of Performer 2 Controlling Hi-Hat Cymbals 17

For example, the performer 2 sits on the chair 27 and places the left leg 30 on the hi-hat pedal 21. In this case, regarding the angle of the shin of the left leg 30, a possible recommended state that can be set is that the ankle is positioned slightly further forward (closer to the hi-hat cymbals 17) than the knee.

Information guiding the angle of the shin of the leg of the performer 2 controlling the hi-hat cymbals 17 to this recommended state is output as the recommended body information. For example, information indicating “Please adjust the settings to adjust the angle of the shin of the left foot such that the ankle side is positioned slightly further forward than the knee” can be output as the recommended body information.

There may be a case that the recommended body information regarding the angle of the shin of the leg of the performer 2 controlling the hi-hat cymbals 17 corresponds to the recommended configuration information regarding the position of the hi-hat cymbals 17 (the hi-hat stand 23). For example, information indicating “Please move the hi-hat cymbals closer to the performer to adjust the angle of the shin of the left foot such that the ankle side is positioned slightly further forward than the knee” may be output as recommended information included in both the recommended body information and the recommended configuration information.

### Information Regarding Positional Relationship Between Floor Tom 16 and Body of Performer 2

For example, the performer 2 sits on the chair 27 with the body of the performer 2 directly behind the snare drum 13, and places the right leg 31 on the kick pedal 20. In this case, a possible recommended state that can be set is that when viewed from above, the thigh of the right leg 31 is provided at a middle position between the snare drum 13 and the floor tom 16.

Specifically, a possible state that can be set as the recommended state is that the center of the hitting surface of the snare drum 13 and the center of the hitting surface of the floor tom 16 are approximately bilaterally symmetric relative to an axis extending in the direction in which the thigh of the right leg 31 extends.

Information guiding the positional relationship between the floor tom 16 and the body of the performer 2 to the recommended state is output as the recommended body information.

For example, information indicating “Please adjust the settings to position the thigh of the right leg in the middle of the snare drum and the floor tom with the performer sitting on the chair” can be output as the recommended body information.

There may be a case that the recommended body information regarding the positional relationship between the floor tom 16 and the body of the performer 2 corresponds to the recommended configuration information regarding the position of the floor tom 16. For example, information indicating “Please arrange the floor tom so that the snare drum and the floor tom are bilaterally symmetric relative to the thigh of the right leg with the body of the seated performer directly behind the snare drum” may be output as recommended information included in both the recommended body information and the recommended configuration information.

Information Regarding Positional Relationship between Tom and Arm of Performer 2

For example, the performer 2 is poised with the tips of the drumsticks 34a and 34b aimed at the center of the tom (which is a term encompassing the high tom 14 and the low tom 15). In this case, a possible recommended state that can be set is that the left hand 32 and the right hand 33 (the arms) are not fully stretched, that is, the elbows are slightly bent, allowing for additional movement or flexibility. Another possible state that can be set as the recommended state is that the tom is positioned for easy access by the performer 2.

Information guiding the positional relationship between the tom and the arm of the performer 2 to the recommended state is output as the recommended body information.

For example, information indicating “Please adjust the settings so that the elbows are not fully stretched when the performer plays the high tom and the low tom” can be output as the recommended body information. There may be a case that the recommended body information regarding the positional relationship between the tom and the arm of the performer 2 corresponds to the recommended configuration information regarding the position and the height of the tom. For example, information indicating “Please increase the height of the high tom and the low tom so that the elbows are not fully stretched when the performer plays the high tom and the low tom” may be output as recommended information included in both the recommended body information and the recommended configuration information.

Information Regarding Positional Relationship between Cymbal and Arm of Performer 2

For example, a possible state that can be set as the recommended state is such a body state that the cymbal (which is a term encompassing the crash cymbal 18 and the ride cymbal 19) is positioned for easy access by the performer 2. It is to be noted that there is considerable individual variation in what constitutes a preferable state for striking the cymbal. Such individual variation can be accommodated by setting the recommended state to fit individual needs.

Information guiding the positional relationship between the cymbal and the arm of the performer 2 to the recommended state is output as the recommended body information.

For example, information indicating “Please adjust the settings so that the elbows are not fully stretched when the performer strikes the ride cymbal” can be output as the recommended body information.

There may be a case that the recommended body information regarding the positional relationship between the cymbal and the arm of the performer 2 corresponds to the recommended configuration information regarding the position and the height of the cymbal. For example, information indicating “Please move the ride cymbal closer to the performer so that the elbows are not fully stretched when the performer strikes the ride cymbal” may be output as recommended information included in both the recommended body information and the recommended configuration information.

### Output of Recommended Information (Processing Using Machine Learning)

There is no limitation to the method for the recommended information outputter 8 to generate and output the recommended information; it is possible to use any technique (algorithms).

For example, it is possible to use any machine learning algorithm using a DNN (Deep Neural Network), an RNN (Recurrent Neural Network), or a CNN (Convolutional Neural Network). For example, it is possible to use AI (artificial intelligence) to perform deep learning. This ensures that the recommended information is generated and output with improved accuracy.

The following description is regarding a case that the recommended information is output by performing processing using machine learning.

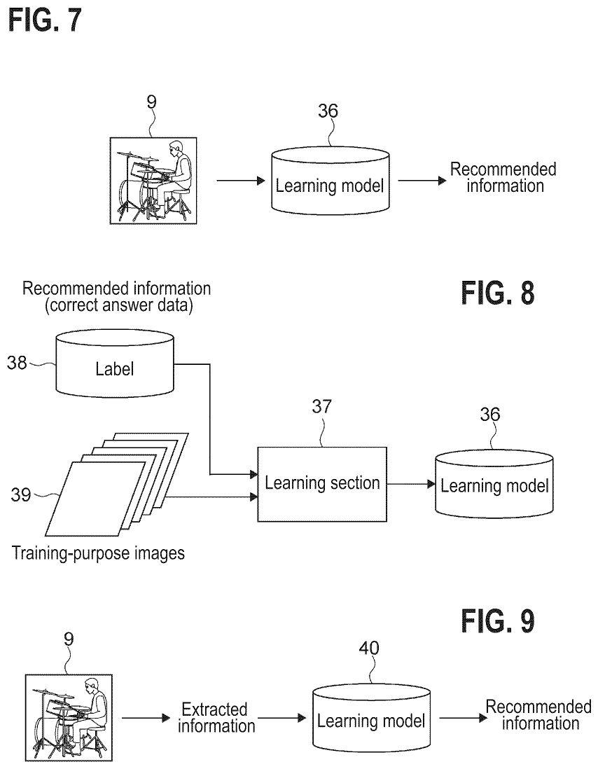

FIG. 7 is a schematic illustration of an example in which recommended information is generated using a trained model. In the example illustrated in FIG. 7, machine learning is performed to generate recommended information. In the machine learning, a performance scene image 9 is used as input. The performance scene image 9 shows a scene of the performer 2 playing the drumming instrument 3.

Specifically, the performance scene image 9 is input into a trained model 36. The trained model 36 is a trained model that has undergone machine learning to estimate recommended information. Then, the recommended information is obtained from the trained model 36. By this processing, the recommended information is evaluated with improved accuracy.

It is to be noted that the trained model 36 can be referred to as machine learning model 36 or trained model 36.

FIG. 8 is a schematic illustration of teaching of the trained model 36 using teaching data.

As illustrated in FIG. 8, teaching data is input into a learning section 37 to cause the trained model 36 to learn. The teaching data correlates learning data with training labels. The teaching data is data for causing the trained model 36 to learn to estimate a correct answer in response to an input.

As illustrated in FIG. 8, in this embodiment, the learning data input into the learning section 37 includes performance scene images 9. Also, recommended information is input into the learning section 37 as training labels 38. Each training label 38 serves as a correct answer (correct answer data) corresponding to a performance scene image 9, which is a training-purpose image.

In this embodiment, the teaching data correlates the recommended information (training labels 38) with training-purpose performance scene images 39 (learning data). The trained model 36, therefore, is a prediction model that has undergone machine learning to learn the teaching data that includes the performance scene images 39 and the recommended information.

There is no limitation to the method of preparing teaching data (a data set of the performance scene images 39, which are training-purpose images, and recommended information). For example, the teaching data may be prepared manually. Another possible example is to obtain teaching data prepared in advance and input the teaching data into the learning section 37.

For example, the recommended information (training labels 38) used as teaching data are correlated the above-described various kinds of recommended configuration information and recommended body information. Then, the trained model 36 is caused to learn the resulting correlated information. This ensures that the above-described various kinds of recommended configuration information and recommended body information are output by performing processing using machine learning. That is, various kinds of recommended information are obtained from the trained model 36.

It is to be noted that in preparing the teaching data, it is important to use such a training-purpose performance scene image 39 (learning data) that includes performance scene images 9 considered to be correlated with the desired recommended information (recommended configuration information and recommended body information).

For example, in the above description, the position of each part of the drumming instrument 3, the height of each part of the drumming instrument 3, the posture of each part of the drumming instrument 3, and the positional relationship between the parts of the drumming instrument 3 are guided to the respective recommended states using various kinds of recommended configuration information.

A performance scene image 9 considered to be correlated with the desired recommended configuration information, among the above-described kinds of recommended configuration information, is used as the performance scene image 39 (learning data). Specifically, the performance scene image 9 used as the performance scene image 39 (learning data) includes an image of parts whose position, height, or any other parameter should be adjusted using the recommended configuration information. In a case that an other object (such as a body part of the performer 2) is needed as a reference to define the recommended state, the performance scene image 9 used as the performance scene image 39 (learning data) also includes the other object serving as a reference.

For example, the performance scene image 9 used as the performance scene image 39 (learning data) allows for determination as to whether the position or another parameter of each part of the drumming instrument 3 are in the respective recommended states. Then, recommended configuration information that guides the position or another parameter of each part of the drumming instrument 3 to the corresponding recommended state is correlated with the performance scene image 39 (learning data) as a training label 38. In this manner, the teaching data is prepared.

For example, there may be a case that a trained model 36 capable of outputting recommended configuration information regarding the height of the chair 27 is desired. To construct such trained model 36, the performance scene image 9 that can be used as the performance scene image 39 (learning data) shows the chair 27 and the thighs of the performer 2 sitting on the chair 27. Then, the performance scene image 39 (learning data) is correlated with recommended configuration information indicating a request to adjust the height of the chair 27 shown in the performance scene image 39 (learning data) to the recommended state. In this manner, the teaching data is prepared.

In the above description, the position of each part of the body of the performer 2, the height of each part of the body of the performer 2, the posture of each part of the body of the performer 2, and the positional relationship between the parts of the body of the performer 2 are guided to the respective recommended states using various kinds of recommended body information.

A performance scene image 9 considered to be correlated with the desired recommended body information, among the above-described kinds of pieces of recommended body information, is used as the performance scene image 39 (learning data). Specifically, the performance scene image 9 used as the performance scene image 39 (learning data) includes an image of body parts of the performer 2 whose posture or another parameter should be adjusted using the recommended body information. In a case that another object (such as a part of the drumming instrument 3) is needed as a reference to define the recommended state, the performance scene image 9 used as the performance scene image 39 (learning data) also includes the other object serving as a reference.

For example, the performance scene image 9 used as the performance scene image 39 (learning data) allows for determination as to whether the posture or another parameter of each part of the body of the performer 2 are in the respective recommended states. Then, recommended configuration information that guides the posture or another parameter of each part of the body of the performer 2 to the corresponding recommended state is correlated with the performance scene image 39 (learning data) as a training label 38. In this manner, the teaching data is prepared.

For example, there may be a case that a trained model 36 capable of outputting the recommended body information regarding the angle of the thighs of the performer 2 sitting on the chair 27 is desired. To construct such trained model 36, the performance scene image 9 that can be used as the performance scene image 39 (learning data) shows the thighs of the performer 2 sitting on the chair 27 in a manner that the angle of the thighs of the performer 2 is identifiable. Then, the performance scene image 39 (learning data) is correlated with recommended body information that guides the angle of the thighs of the performer 2 shown in the performance scene image 39 (learning data) to the recommended state. In this manner, the teaching data is prepared.

As illustrated in FIG. 8, the learning section 37 uses teaching data to cause the trained model 36 to learn based on a machine learning algorithm. By this learning, a parameter (coefficient) used to calculate a correct answer (training label) is updated and generated as a trained parameter. A program incorporating the generated trained parameter is generated as the trained model 36.

A possible method of causing the trained model to learn is error inverse propagation. Error inverse propagation (backpropagation) is a widely used learning method for neural network learning. As used herein, the term “neural network” is intended to mean a model with a three-layer structure made up of an input layer, an intermediate layer (hidden layer), and an output layer. This model is designed to simulate the network of neurons in the human brain.

A neural network with a large number of intermediate layers is referred to as a deep neural network. A deep neural network is caused to learn by deep learning technology enabling the deep neural network to learn complicated patterns hidden in a large amount of data. Error inverse propagation is one way by which a deep neural network learns. For example, error inverse propagation is used for learning of a CNN, which is used to recognize still and moving images.

This kind of machine learning may be implemented by a hardware structure, such as a neuro chip and neuromorphic chip, in which neural network concepts are incorporated.

There is no limitation to the algorithm to cause the trained model 36 to learn; any machine learning algorithm may be used.

Machine learning algorithm examples include a supervised learning algorithm, an unsupervised learning algorithm, a semi-supervised learning algorithm, a reinforcement learning algorithm, an inverse reinforcement learning algorithm, an active learning algorithm, and a transfer learning algorithm.

Machine learning models such as HMM (Hidden Markov Model) and SVM (Support Vector Machine) may also be used.

The trained model 36 generated by the learning section 37 is incorporated in the recommended information outputter 8 illustrated in FIG. 1. Then, the recommended information outputter 8 estimates recommended information.

It is to be noted that the learning section 37 illustrated in FIG. 8 may be included in illustrated in FIG. 1 the information processing apparatus according to the present disclosure, such as the smartphone 5 so that the information processing apparatus may cause the trained model 36 to learn.

It is also to be noted that the learning section 37 may be provided outside the information processing apparatus according to the present disclosure. That is, the learning section 37 may cause the trained model 36 to learn in advance outside the information processing apparatus according to the present disclosure, and only the trained model 36 may be incorporated in the recommended information outputter 8.

Otherwise, there is no limitation to a specific configuration of the trained model 36 and a specific configuration of the learning section 37 regarding the learning of the trained model 36.

It is to be noted that the machine learning algorithm may be applied to any processing in the present disclosure. That is, the processing using machine learning may be applied to any processing described in the present disclosure.

### Output of Recommended Information Using Extracted Information

FIG. 9 is a schematic illustration of an example in which the recommended information is generated using a trained model that receives, as input information, extracted information extracted from the performance scene image 9.

As illustrated in FIG. 9, machine learning is performed using, as input, extracted information extracted from the performance scene image 9 to estimate the recommended information. For example, any of the above-described various kinds of extracted information may be used.

The extracted information extracted from the performance scene image 9 is input into a trained model 40. The trained model 40 has undergone the machine learning to estimate the recommended information. By inputting the extracted information into the trained model 40, processing of obtaining the recommended information from the trained model 40 is performed. This ensures that the recommended information is generated and output with improved accuracy.

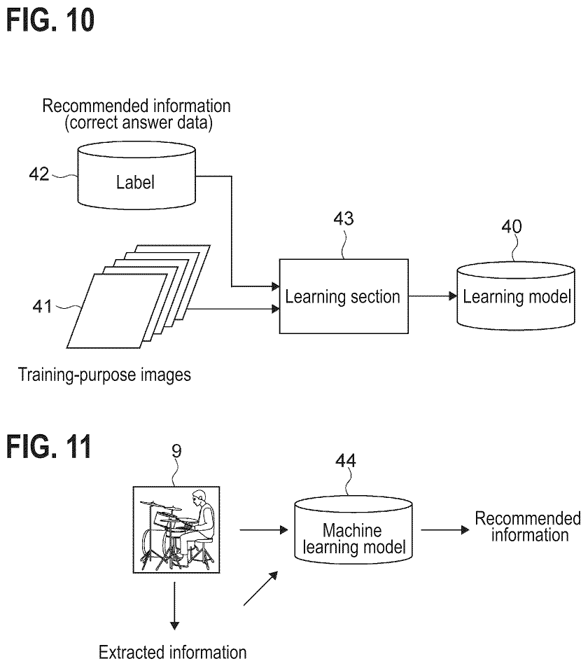

FIG. 10 is a schematic illustration of how the trained model 40 learns using teaching data.

In this embodiment, extracted information 41 is used as learning data. The extracted information 41 is extracted from the performance scene image 9. Data that correlates this learning data with recommended information (training labels 42) is used as teaching data.

Thus, the trained model 40 is a prediction model that has undergone machine learning with teaching data being the extracted information 41, which is extracted from the performance scene image 9, the recommended information.

As illustrated in FIG. 10, a learning section 43 uses the teaching data to train the trained model 40 based on a machine learning algorithm. Thus, the trained model 40 is generated.

There is no limitation to the algorithm to train the trained model 40; any machine learning algorithm may be used.

It is to be noted that recommended information (training labels 42) used as the teaching data is correlated with the above-described various kinds of recommended configuration information and recommended body information. The trained model 40 is caused to learn the resulting correlated information. This ensures that the above-described various kinds of recommended configuration information and recommended body information are output by performing processing using machine learning. That is, various kinds of recommended information are obtained from the trained model 40.

It is to be noted that in preparing the teaching data, it is important to use such the training-purpose extracted information 41 (learning data) that includes extracted information considered to be correlated with the desired recommended information (recommended configuration information and recommended body information).

For example, extracted information considered to be correlated with the desired recommended configuration information is used as the training-purpose extracted information 41. Specifically, extracted information regarding parts whose position, height, or any other parameter should be adjusted using the recommended configuration information, or extracted information regarding another object needed as a reference to define the recommended state can be used as the training-purpose extracted information 41 (learning data). Also, various other kinds of extracted information that can be used to determine whether the position or another parameter of each part of the drumming instrument 3 are in the respective recommended states can be used as the training-purpose extracted information 41 (learning data).

For example, a performance scene image 9 considered to be correlated with the desired recommended configuration information is selected as an extraction-origin performance scene image 9. Then, extracted information considered to be correlated with the desired recommended configuration information is extracted from this performance scene image 9 and used as the training-purpose extracted information 41 (learning data).

Then, the extracted information is correlated with recommended configuration information as a training label 42. This recommended configuration information guides the position or another parameter of each part of the drumming instrument 3 to the respective recommended states in the extraction-origin performance scene image 9. In this manner, the teaching data is prepared.

Also, extracted information considered to be correlated with the desired recommended body information is used as the training-purpose extracted information 41. Specifically, extracted information regarding the body part of the performer 2 whose posture or another parameter should be adjusted using the recommended body information, extracted information regarding another object needed as a reference to define the recommended state can be used as the training-purpose extracted information 41 (learning data). Also, various other kinds of extracted information that can be used to determine whether the posture or another parameter of each part of the body of the performer 2 are in the respective recommended states can be used as the training-purpose extracted information 41 (learning data).

For example, a performance scene image 9 considered to be correlated with the desired recommended body information is selected as an extraction-origin performance scene image 9. Then, extracted information considered to be correlated with the desired recommended body information is extracted from this performance scene image 9 and used as the training-purpose extracted information 41 (learning data).

Then, the extracted information is correlated with recommended body information as a training label 42. This recommended body information guides the posture or another parameter of each part of the body of the performer 2 to the respective recommended state in the extraction-origin performance scene image 9. In this manner, the teaching data is prepared.

FIG. 11 is a schematic illustration of an example in which recommended information is generated using a trained model that receives, as input information, both the performance scene image 9 and the extracted information.

As illustrated in FIG. 11, to estimate the recommended information, machine learning is performed using, as input, both the performance scene image 9 and the extracted information extracted from the performance scene image 9.

Both the performance scene image 9 and the extracted information extracted from the performance scene image 9 are input into a trained model 44. The trained model 44 has undergone the machine learning to estimate the recommended information. By inputting these pieces of information into the trained model 44, processing of obtaining the recommended information from the trained model 44 is performed. This ensures that the recommended information is generated with improved accuracy.

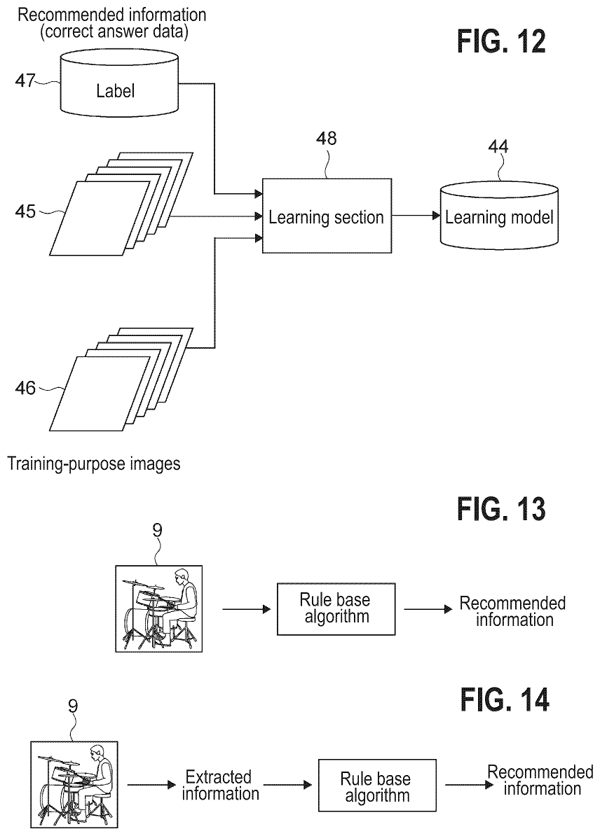

FIG. 12 is a schematic illustration of how the trained model 44 learns using teaching data.

In this embodiment, a combination of a training-purpose performance scene image 45 and training-purpose extracted information 46 is used as the learning data. The extracted information 46 is extracted from the performance scene image 45. Data that correlates this learning data with recommended information (training labels 47) is used as teaching data.

Thus, the trained model 44 is a prediction model that has undergone machine learning with teaching data being the recommended information and the combination of the performance scene image 45 and the extracted information 46, which is extracted from the performance scene image 45.

As illustrated in FIG. 12, a learning section 48 uses teaching data to cause the trained model 36 to learn based on a machine learning algorithm. In this manner, the trained model 44 is generated.

There is no limitation to the algorithm to train the trained model 44; any machine learning algorithm may be used.

It is to be noted that the recommended information (training labels 47) used as the teaching data are correlated with the above-described various kinds of recommended configuration information and recommended body information. The trained model 44 is caused to learn the resulting correlated information. This ensures that the above-described various kinds of recommended configuration information and recommended body information are output by performing processing using machine learning. That is, various kinds of recommended information are obtained from the trained model 44.

It is to be noted that in preparing the teaching data, it is important to use such performance scene image 45 and extracted information 46 (learning data) that include a combination of a performance scene image 9 and extracted information that are considered to be correlated with the desired recommended information (recommended configuration information and recommended body information).

For example, a performance scene image 9 considered to be correlated with the desired recommended configuration information is used as the performance scene image 45. Also, extracted information extracted from the performance scene image 45 and considered to be correlated with the desired recommended configuration information is used as the extracted information 46.

Then, the combination of the performance scene image 45 and the extracted information 46 is correlated with recommended configuration information as a training label 47. This recommended configuration information guides the posture or another parameter of each part of the drumming instrument 3 to the respective recommended states in the performance scene image 45. In this manner, the teaching data is prepared.

Also, a performance scene image 9 considered to be correlated with the desired recommended body information is used as the performance scene image 45. Also, extracted information extracted from the performance scene image 45 and considered to be correlated with the desired recommended body information is used as the extracted information 46.

Then, the combination of the performance scene image 45 and the extracted information 46 is correlated with recommended body information as a training label 47. This recommended body information guides the posture or another parameter of each part of the body of the performer 2 to the respective recommended state in the performance scene image 45. In this manner, the teaching data is prepared.

In the examples illustrated in FIGS. 7 to 12, machine learning is performed using the performance scene image 9 and/or extracted information as input to output the recommended information.

This configuration, however, is not intended in a limiting sense. Another possible example is that the recommended information is output by performing machine learning using the above-described various kinds of configuration information or various kinds of body information as input. In this case, the training-purpose information corresponding to the information input into the trained model is correlated with the desired recommended information. This correlated information is used as teaching data. Then, the trained model may be caused to learn using the teaching data.

That is, at least one of the configuration information or the body information is input into the trained model that has undergone machine learning to estimate the recommended information. In this manner, the recommended information is obtained from the trained model.

For example, it is also possible to output the recommended information by machine learning upon input of any combination of the above-described configuration information and body information. In this case, a trained model is constructed using, as teaching data, the combination of the configuration information and the body information and the desired recommended information.

Another possible example is to output the recommended information by performing machine learning using any one of the configuration information or the body information as input. In this case, a trained model is constructed using, as teaching data, any one of the configuration information or the body information and the desired recommended information.

Thus, it is possible to use a trained model (estimation model) that has undergone machine learning using, as teaching data, at least one of the configuration information or the body information and the recommended information.

A possible example is that a trained model is constructed for each configuration information, and body information is input into the trained model to output recommended information. Specifically, a trained model is constructed for each type of the drum set 4 or for each basic configuration of the drum set 4. Then, a trained model is selected suitable for the configuration information input from the performer 2 (such as the drum set 4's type or basic configuration). Then, the body information input from the performer 2 is input into the selected trained model. In response to the body information, the selected trained model outputs recommended information. This configuration is also practicable.

Another possible example is that a trained model is constructed for each type of body information, and configuration information is input into the trained model to output recommended information. For example, a trained model is constructed for each classification of the height of the performer 2. Specifically, a trained model corresponding to a height of 100 cm to 120 cm, a trained model corresponding to a height of 120 cm to 140 cm, a trained model corresponding to a height of 140 cm to 160 cm, a trained model corresponding to a height of 160 cm to 180 cm, a trained model corresponding to a height of 180 cm to 200 cm are constructed.

Then, a trained model is selected suitable for the height input from the performer 2. Then, the configuration information input from the performer 2 is input into the selected trained model. In response to the configuration information, the selected trained model outputs recommended information. This configuration is also practicable.

### Output of Recommended Information (Processing Using Rule Base)

FIGS. 13 to 15 each are a schematic illustration of the recommended information output by performing processing using a rule base.

As illustrated in FIGS. 13 to 15, the recommended information outputter 8 may performs processing using a rule base to generate and output the recommended information.

In the example illustrated in FIG. 13, processing using a rule base algorithm is performed using the performance scene image 9 as input to generate and output the recommended information.

In the example illustrated in FIG. 14, processing using a rule base algorithm is performed using the extracted information extracted from the performance scene image 9 as input to generate and output the recommended information.

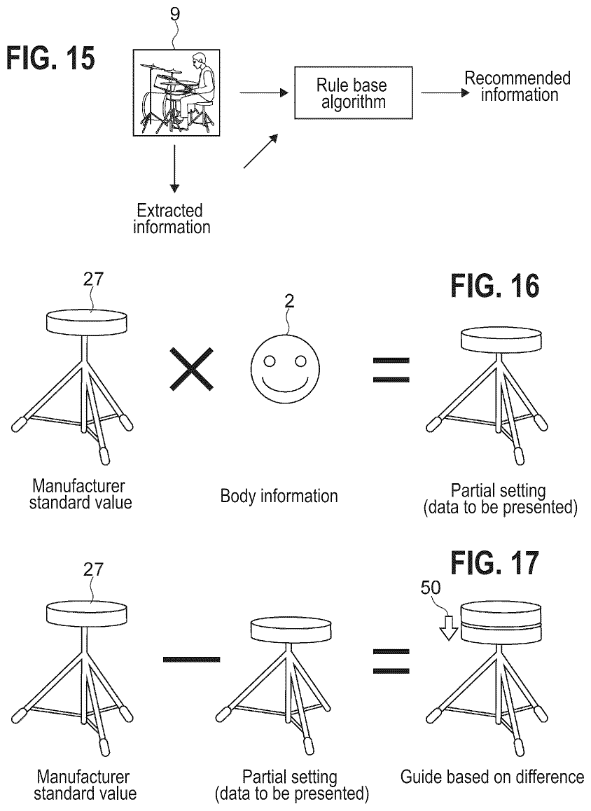

In the example illustrated in FIG. 15, processing using a rule base algorithm is performed using both the performance scene image 9 and the extracted information extracted from the performance scene image 9 as input to generate and output the recommended information.

The configuration in which the performance scene image 9 and/or extracted information are used as input is not intended in a limiting sense. Another possible example is that the recommended information is generated and output by performing rule base processing using the above-described various kinds of configuration information or various kinds of body information as input.

Specifically, it is possible to output the recommended information by performing rule base processing using a combination of the configuration information and the body information as input or using any one of the configuration information or the body information as input rule base.

There is no limitation to a specific algorithm performed as rule base processing. Any rule base algorithm may be used such as matching technology, image recognition technology, and analysis technology.

### Partial Customization Based on Manufacturer Standard Value

FIGS. 16 to 18 each are a schematic illustration of a customized (semi-customized) setting based on a manufacturer standard value.

The manufacturer of the drumming instrument 3 or another entity may prepare information indicating a standard setting(s) for the drumming instrument 3 in the form of, for example, a manufacturer standard value.

In the drum setting assistance system 1, a standard configuration indicated by information such as a manufacturer standard value may be used as a reference to partially customize each setting to fit the performer 2. Then, recommended information may be output that serves as a guide to incorporate the partially customized setting into the actual hardware.

By referring to FIGS. 16 to 18, partial customization will be described with the height of the chair 27 taken as an example. It will be readily appreciated that not only the height of the chair 27 but also various configurations regarding the drumming instrument 3 (the drum set 4) can be partially customized.

As illustrated in FIG. 16, the recommended information outputter 8 partially customizes the height of the chair 27 based on a manufacturer standard value for the height of the chair 27 and body information regarding the body of the performer 2. As a result of the partial customization, the height of the chair 27 is calculated. The height of the chair 27 partially customized relative to the manufacturer standard value is shown to the performer 2. In this manner, the partially customized setting for the height of the chair 27 is incorporated into the actual hardware.

The manufacturer standard value can be obtained by, for example, accessing a database managed by the manufacturer.

As illustrated in FIG. 17, the recommended information outputter 8 may calculate difference information 50. The difference information 50 indicates the difference between manufacturer standard value and the partially customized height of the chair 27. By outputting the calculated difference information 50, the standard configuration can be guided to the partially customized setting. This ensures that the partially customized setting can be easily incorporated into the actual hardware.

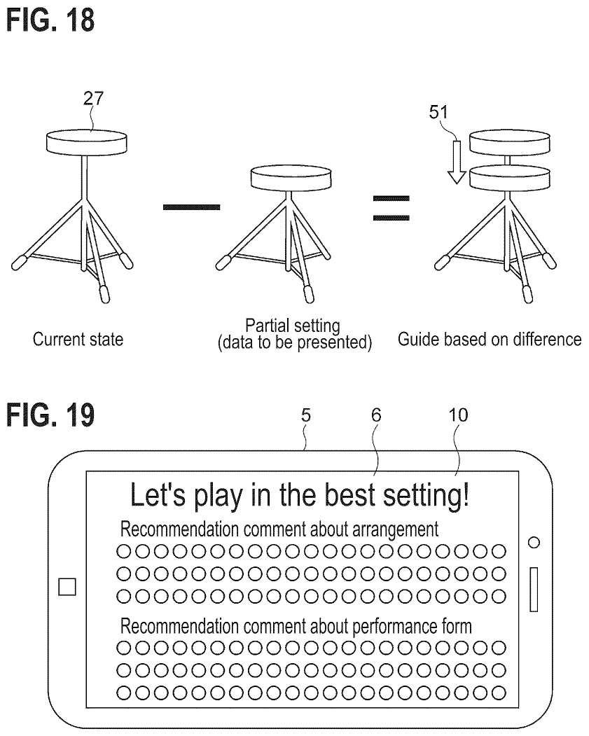

As illustrated in FIG. 18, the recommended information outputter 8 may calculate difference information 51. The difference information 51 indicates the difference between the current setting (the height of the chair 27) and the partially customized height of the chair 27. By outputting the calculated difference information 51, the current setting can be guided to the partially customized setting. This ensures that the partially customized setting can be easily incorporated into the actual hardware.

In the examples illustrated in FIGS. 16 to 18, the manufacturer standard value is included in standard configuration information. The standard configuration information indicates the standard configuration of the drumming instrument 3.

Also, the information regarding the manufacturer standard value and the information regarding the current setting are included in configuration information obtained by the first obtainer 7. That is, the manufacturer standard value is included in both the standard configuration information and the configuration information.

The body information regarding the body of the performer 2 illustrated in FIG. 16 is included in body information obtained by the first obtainer 7.

The partially customized setting information and the difference information 50 and 51, which serve as setting guides, is included in the recommended information output by the recommended information outputter 8.

That is, the recommended information outputter 8 is capable of outputting, as the recommended information, difference information indicating the difference between the partially customized setting and the standard configuration information (which indicates the standard configuration of the drumming instrument 3).

### Specific Example of Output of Recommended Information

FIGS. 19 to 28 each are a schematic illustration of a specific example of the output of the recommended information.

By referring to FIGS. 19 to 28, description will be made with regard to a specific example of the output of the recommended information; specifically, the recommended information is displayed on the touch panel 6 of the smartphone 5.

For example, the performer 2 downloads an application (application program) for using the drum setting assistance system 1 on the smartphone 5.

For example, the performer 2 inputs information such as ID (identification) and a password to create an account for using the drum setting assistance system 1. It will be readily appreciated that an account may not necessarily be created in some applications.

The performer 2 activates the application for using the drum setting assistance system 1 to input configuration information and body information.

For example, the performer 2 uses a camera incorporated in the smartphone 5 to take a performance scene image 9. For example, the performer 2 places the smartphone 5 in front of the drum set 4 and starts the smartphone 5 in video mode. Then, the performer 2 captures the performance scene image 9 while playing the drum set 4. It will be readily appreciated that another person may take the performance scene image 9 of the performer 2 playing the drum set 4.

Another possible example is to input the configuration information and the body information via various GUIs displayed on the touch panel 6. It will be readily appreciated that the configuration information and the body information may be input in the form of sound.

The first obtainer 7 illustrated in, for example, FIG. 1 obtains configuration information and body information.

The recommended information outputter 8 performs processing using the machine learning exemplified in FIGS. 7 to 12 or the processing using a rule base exemplified in FIGS. 13 to 15 to generate and output the recommended information.

In the example illustrated in FIG. 19, the recommendation comment 10 is displayed on the touch panel 6.

Specifically, “Recommendation comment about arrangement” is displayed as the recommended configuration information. As the recommended body information, “Recommendation comment about performance form” is displayed.

Examples of comment details include the above-described various kinds of recommended configuration information and the above-described various kinds of recommended body information. Along with these examples, it is also possible to display information indicating a recommended state of the setting that the performer 2 desires, or information indicating why such state is set as a recommended state.

The recommendation comment 10 may be read aloud, in the form of sound.

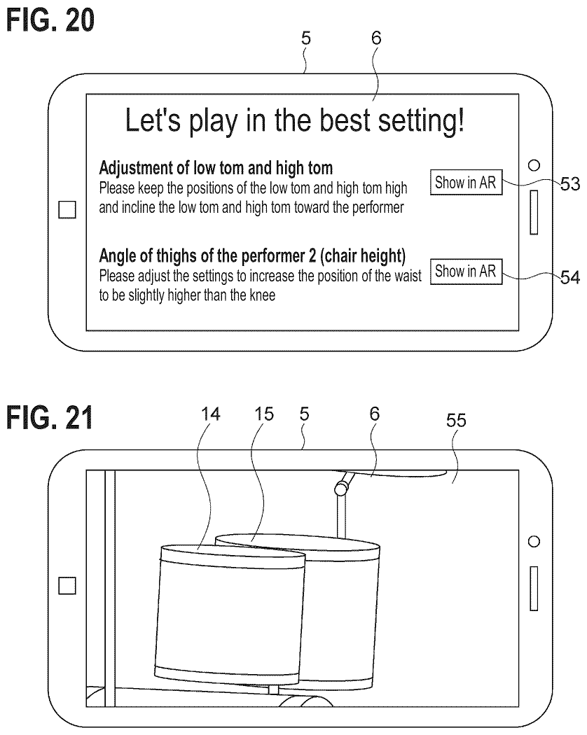

In the example illustrated in FIG. 20, as recommended configuration information for “Adjustment of low tom and high tom”, a recommendation comment: “Please keep the positions of the low tom and high tom high and incline the low tom and high tom toward the performer” is displayed.

Also, as recommended body information for “Angle of thighs of the performer 2 (the height of the chair)”, a recommendation comment: “Please adjust the settings to increase the position of the waist to be slightly higher than the knee” is displayed.

Also in the example illustrated in FIG. 20, an AR button 53 is displayed beside the recommendation comment regarding “Adjustment of low tom and high tom”. Similarly, an AR button 54 is displayed beside the recommendation comment regarding “Angle of thighs of the performer 2 (the height of the chair)”.

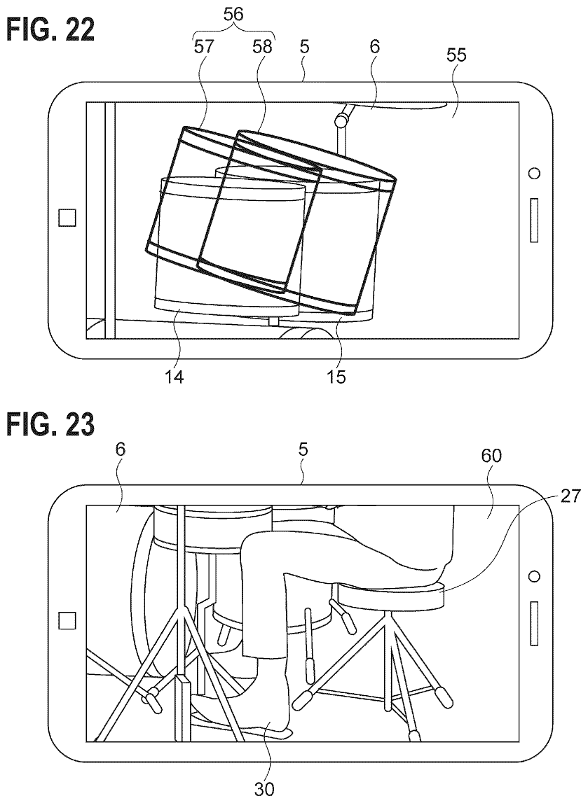

Upon selection of the AR button 53 illustrated in FIG. 20, the images (screens) illustrated in FIGS. 21 and 22 are displayed in such a manner that, for example, these images are mutually switchable.

The image illustrated in FIG. 21 is a captured image 55 of the high tom 14 and the low tom 15. The captured image 55 has been input as the configuration information, and is an image showing the current setting state.

In the example illustrated in FIG. 22, a virtual image 56 of the drum set 4 is displayed as the recommended configuration information. The virtual image 56 is also referred to as an AR (Augmented Reality) image, and is superimposed over a real image.

In this embodiment, the captured image 55 of the high tom 14 and the low tom 15 illustrated in FIG. 21 is regarded as a real image, a virtual image 57 of the high tom 14 and a virtual image 58 of the low tom 15 are superimposes on the captured image 55.

The virtual images 57 and 58 are images showing recommended states for the settings of the high tom 14 and the low tom 15 to suit the body of the performer 2. The virtual images 57 and 58 also correspond to the recommendation comment: “Please keep the positions of the low tom and high tom high and incline the low tom and high tom toward the performer”, illustrated in FIG. 20.

The performer 2 is able to visually recognize the virtual images 57 and 58, which are respectively superimposed over the real images of the high tom 14 and the low tom 15. Thus, the performer 2 is able to intuitively understand the optimal setting states (recommended states) suitable for the body of the performer 2. This enables the performer 2 to easily adjust to the optimal settings for the high tom 14 and the low tom 15 suitable for the body of the performer 2.

Thus, in the drum setting assistance system 1, as the recommended configuration information, the virtual image 56 of the drumming instrument 3 can be displayed superimposed over the real image of the drumming instrument 3. With this configuration, the drum setting assistance system 1 provides adequate support for setting the drumming instrument 3 with improved accuracy.

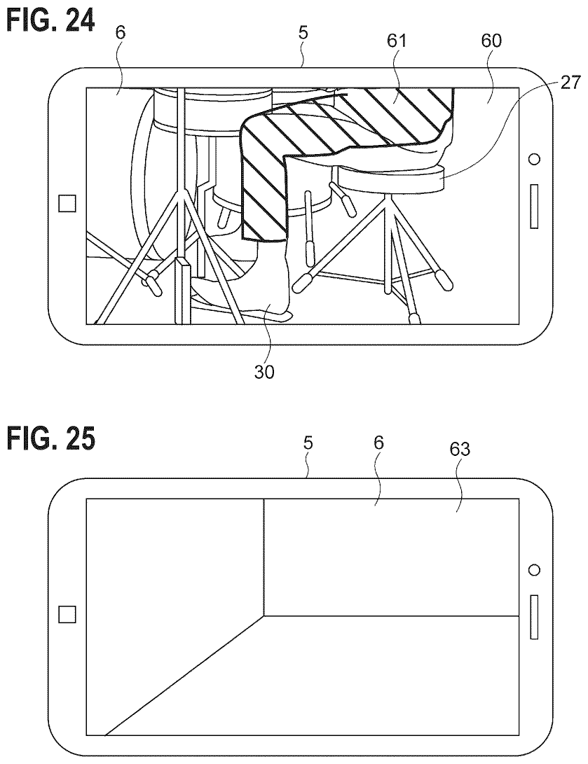

Upon selection of the AR button 54 illustrated in FIG. 20, the images (screens) illustrated in FIGS. 23 and 24 image (screen) are displayed in such a manner that, for example, these images are mutually switchable.

The image illustrated in FIG. 23 is a captured image 60 including the thigh of the left leg 30 of the performer 2. The captured image 60 has been input as the body information, and is an image showing the current setting state.

In the example illustrated in FIG. 24, a virtual image 61 of the body of the performer 2 is displayed as the recommended body information. The virtual image 61 is superimposed over the real image of the body of the performer 2.

In this embodiment, the captured image 60, which includes the thigh illustrated in FIG. 23, is treated as a real image. The virtual image 61, which includes the thigh, is superimposed over the real image. The virtual image 61 is an image showing a suitable angle of the thigh of the performer 2 so that the posture of the performer 2 is in the recommended state. The virtual image 61 is also an image corresponding to recommendation comment: “Please adjust the settings to increase the position of the waist to be slightly higher than the knee”, illustrated in FIG. 20.

The performer 2 is able to visually recognize the virtual image 61 superimposed on the actual thigh. Thus, the performer 2 is able to intuitively understand the optimal posture (recommended state) for the performer 2 in playing the drum set 4. This enables the performer 2 to easily adjust to the optimal settings to assume the optimal posture. Specifically, the performer 2 is able to easily increase the height of the chair 27 to set the angle of the thigh of the performer 2 to the optimal state.

Thus, in the drum setting assistance system 1, as the recommended body information, the virtual image 61 of the body of the performer 2 can be displayed superimposed over the real image of the body of the performer 2. With this configuration, the drum setting assistance system 1 provides adequate support for setting the drumming instrument 3 with improved accuracy.

In the example illustrated in FIG. 25, the smartphone 5 captures an image of the inside of a room in the real world, and the image is displayed on the touch panel 6 as a captured image 63 of the room.

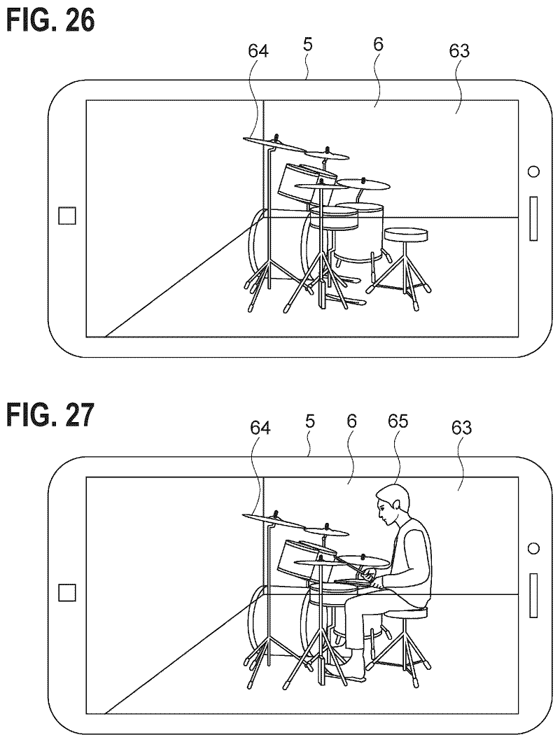

In the example illustrated in FIG. 26, the captured image 63 of the room illustrated in FIG. 25 is treated as a real image. A virtual image 64 of the entire drum set 4 is superimposed over the real image. The virtual image 64 of the drum set 4 is an image generated as the recommended configuration information, and indicates the optimal setting state (recommended state) that suits the body of the performer 2.

For example, the virtual image 64 of the recommended-state drum set 4 can be enlarged or diminished by operating the touch panel 6.

The performer 2 is able to visually recognize the virtual image of the drum set 4 displayed in the room. Thus, the performer 2 is able to intuitively understand the optimal setting state (recommended state) suitable for the body of the performer 2. This enables the performer 2 to easily adjust to the optimal settings for each part of the drum set 4 to suit the body of the performer 2. With this configuration, the drum setting assistance system 1 provides adequate support for setting the drumming instrument 3 with improved accuracy.

In the example illustrated in FIG. 27, the touch panel 6 displays both the virtual image 64 of the entire drum set 4 and a virtual image 65. The virtual image 65 shows the entire body of the performer 2 playing the drum set 4.

The virtual image 65 of the body of the performer 2 is an image generated as the recommended body information, and shows the body of the performer 2 in the recommended state.

Specifically, in the example illustrated in FIG. 27, the following images are AR displayed in the actual room: the drum set 4 that is in the recommended state suitable for the body of the performer 2; and the performer 2 playing the drum set 4 while assuming a recommended-state posture.

It will be readily appreciated that the virtual image 64 of the drum set 4 and the virtual image 65 of the body of the performer 2 can be enlarged or diminished by operating the touch panel 6.

The performer 2 is able to visually recognize the images displayed in the room, namely, the virtual image 64 of the drum set 4 and the virtual image 65 of the body of the performer 2. Thus, the performer 2 is able to intuitively understand the optimal setting states (recommended states) for the configuration of the drum set 4 and the body of the performer 2.

This enables the performer 2 to easily adjust to the optimal settings to realize an ideal performance. With this configuration, the drum setting assistance system 1 provides adequate support for setting the drumming instrument 3 with improved accuracy.

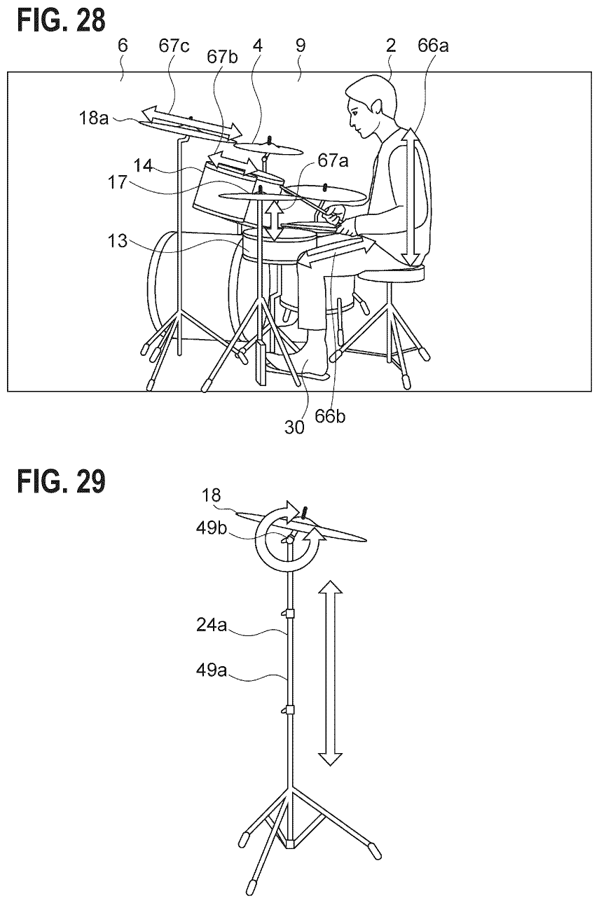

In the example illustrated in FIG. 28, a performance scene image 9 is displayed on the touch panel 6. This performance scene image 9 is treated as a real image. This real image is superimposed by a virtual image showing the state of a part of the drum set 4 and a virtual image showing the state of a part of the body of the performer 2.

Specifically, a virtual image 66a and a virtual image 66b are superimposed over the real image. The virtual image 66a shows the posture of the body of the performer 2. The virtual image 66b shows the posture (angle) of the thigh of the left leg 30.

Also, a virtual image 67a, a virtual image 67b, and a virtual image 67c are superimposed over the real image. The virtual image 67a indicates the height difference between the hi-hat cymbals 17 and the snare drum 13. The virtual image 67b indicates the posture (position, height, and inclination) of the high tom 14. The virtual image 67c indicates the posture (position, height, and inclination) of the crash cymbal 18a.

Thus, these images may be displayed as the recommended information, namely: the virtual images 66a and 66b, which indicate the states of some parts of the drum set 4; and the virtual images 67a to 67c, which indicate the states of some parts of the body of the performer 2. In this case, the virtual images 66a and 66b, which indicate the states of some parts of the drum set 4, are information included in the recommended configuration information. Also in the above case, the virtual images 67a to 67c, which indicate the states of some parts of the body of the performer 2, are information included in the recommended body information.

The performer 2 is able to visually recognize the virtual images illustrated in FIG. 28. Thus, the performer 2 is able to easily check the current setting states and adjust to the optimal settings.

It will be readily appreciated that instead of or in addition to the virtual images illustrated in FIG. 28, it is possible to display a virtual image showing a recommended state of each part of the drum set 4.

For example, instead of or in addition to the virtual image 66a, which shows the current posture of the body of the performer 2, it is possible to display a virtual image showing a recommended-state posture of the body of the performer 2.

For another example, instead of or in addition to the virtual image 67a, which shows the height difference between the hi-hat cymbals 17 and the snare drum 13, it is possible to display a virtual image showing a recommended-state height difference between the hi-hat cymbals 17 and the snare drum 13. These virtual images as well are information included in the recommended information (recommended configuration information and recommended body information).

The performer 2 is able to visually recognize the recommended-state virtual images to easily adjust to the optimal settings.

It is to be noted that the configuration in which a virtual image is superimposed over a captured image may also be regarded as an AR representation in which a virtual image is superimposed over the real object displayed in the captured image.

It will be readily appreciated that a virtual image may be displayed as recommended information in a manner in which the virtual image is not superimposed over the real object. For example, a virtual image showing the recommended state of each part of the drum set 4 or a virtual image showing the recommended state of each part of the body of the performer 2 may be displayed without being superimposed over the real object. In this case as well, the performer 2 is able to visually recognize the virtual image to easily adjust to the optimal settings.

In setting the drumming instrument 3, there may be a case that the parts of the drumming instrument 3 are assembled while being arranged in order.

For example, there may be a case that the following arranging steps are performed at the time of the setting of the drum set 4 exemplified in FIG. 4 and related figures.
Arrangement of the chair 27.
Arrangement of the bass drum 12 (setting of the kick pedal 20).
Arrangement of the snare drum 13.
Arrangement of the hi-hat cymbals 17 (the hi-hat stand 23 (the hi-hat pedal 21)).
Arrangement of the high tom 14 and the low tom 15.
Arrangement of the floor tom 16.
Arrangement of the crash cymbals 18a and 18b.
Arrangement of the ride cymbal 19.

In the drum setting assistance system 1, the recommended information may be output based on the performer 2's motions of arranging the parts of the drumming instrument 3 (the drum set 4) in order.

It will be readily appreciated that there is no limitation to the order in which the parts of the drumming instrument 3 (the drum set 4) are arranged, as far as the application of the technique according to this embodiment is concerned. That is, the parts of the drumming instrument 3 (the drum set 4) may be arranged in any order.

For example, as illustrated in FIG. 25, the smartphone 5 in fixed state captures a moving image of the inside of the room in the real world.

The performer 2 arranges the parts of the drum set 4 in order. For example, as described above, the chair 27, the bass drum 12 (the kick pedal 20), the hi-hat cymbals 17 (the hi-hat stand 23 (the hi-hat pedal 21)), the high tom 14 and the low tom 15, the floor tom 16, the crash cymbals 18a and 18b, and the ride cymbal 19 arranged in order in the room.

The captured image (video) showing how the parts of the drum set 4 are arranged is obtained by the first obtainer 7 as the configuration information and the body information.

Then, the recommended information is output based on the performer 2's motions of arranging the parts of the drum set 4. For example, the above-described various kinds of recommended configuration information and recommended body information may be output.

It is also possible to output information guiding the arrangement of the parts in order, such as “First, please arrange the chair 27 and sit down”, “Next, please arrange the bass drum and put foot on the kick pedal”, and “Please arrange the snare drum and be poised holding drumsticks”.

First, when the chair 27 is arranged, it is possible to output: recommended configuration information regarding the position and the height of the chair 27; and the recommended body information regarding the angle of the thighs of the performer 2 sitting on the chair 27.

Next, when the bass drum 12 is arranged, it is possible to output, for example, the recommended configuration information regarding the position and the inclination of the bass drum 12. It is also possible to output: the recommended body information regarding the positional relationship between the bass drum 12 and the leg striking the bass drum 12; and the recommended body information regarding the angle of the shin of the leg striking the bass drum 12.

Next, when the snare drum 13 is arranged, it is possible to output, for example, the recommended configuration information regarding the position, the height, and the inclination of the snare drum 13. It is also possible to output: the recommended body information regarding the positional relationship between the snare drum 13 and the body of the performer 2; the recommended body information regarding the positional relationship between the upper arm and the body of the performer 2 playing the snare drum; and the recommended body information regarding the height relationship between the snare drum 13, the elbow, and the knee.

Next, when the hi-hat cymbals 17 (the hi-hat stand 23 (the hi-hat pedal 21)) is arranged, it is possible to output, for example: the recommended configuration information regarding the position and the height of the hi-hat cymbals 17; and the recommended configuration information regarding the height difference between the snare drum 13 and the hi-hat cymbals 17. It is also possible to output: the recommended body information regarding the positional relationship between the hi-hat cymbals 17 and the leg of the performer 2 controlling the hi-hat cymbals 17; and the recommended body information regarding the angle of the shin of the leg of the performer 2 controlling the hi-hat cymbals 17.

Next, when the tom (which is a term encompassing the high tom 14 and the low tom 15) is arranged, it is possible to output, for example: the recommended configuration information regarding the position, the height, and the inclination of the tom; and the recommended body information regarding the positional relationship between the tom and the arm of the performer 2.

Next, when the floor tom 16 is arranged, it is possible to output, for example: the recommended configuration information regarding the position, the height, and the inclination of the floor tom 16; and the recommended body information regarding the positional relationship between the floor tom 16 and the body of the performer 2.

Next, when the cymbal (which is a term encompassing the crash cymbals 18a and 18b and the ride cymbal 19) is arranged, it is possible to output, for example: the recommended configuration information regarding the position, the height, and the inclination of the cymbal; and the recommended body information regarding the positional relationship between the cymbal and the arm of the performer 2.

For example, based on the performer 2's motion of arranging each part, the touch panel 6 displays a virtual image of each part as its recommended state. The performer 2 is able to visually recognize the virtual image of the each part displayed on the touch panel 6. Thus, the performer 2 is able to easily set the each part in its optimal state (recommended state) for the body of the performer 2. As a result, the drum setting assistance system 1 provides adequate support for setting the drumming instrument 3 with improved accuracy.

It will be readily appreciated that the display of virtual images is not intended in a limiting sense; the recommended information may be output in any form such as the display of a recommendation comment.

It will be assumed that an AR glass is used as one embodiment of the information processing apparatus according to the present disclosure. An example of the AR glass is an HMD (Head-Mounted Display) mountable on the head of the performer 2.

In this case, the recommended information (recommended configuration information and recommended body information) may be displayed on a display section of the AR glass. For example, it will be assumed that the performer 2 is in the state of playing the drumming instrument 3 currently set up.

A virtual image of the drumming instrument 3 or a virtual image of the body of the performer 2 may be superimposed as the recommended information over real objects such as the drumming instrument 3 and the body of the performer 2 with the drumming instrument 3 and the body of the performer 2 included within the field of vision of the performer 2.

This enables the performer 2 to easily adjust to the optimal settings while visually checking the virtual image displayed on the display section of the AR glass.

It will be assumed that a VR glass is used as one embodiment of the information processing apparatus according to present disclosure. An example of the VR glass is an HMD (Head-Mounted Display) mountable on the head of the performer 2.

In this case, the recommended information (recommended configuration information and recommended body information) may be displayed on a display section of the VR glass. For example, it will be assumed that the performer 2 is in the state of playing the drumming instrument 3 currently set up.

A 3D model image of the drumming instrument 3 and the body of the performer 2 is displayed on the display section of the VR glass as a virtual image (VR image). Specifically, the drumming instrument 3 and the body of the performer 2 shown in the 3D model image are provided at positions respectively corresponding to the positions of the real drumming instrument 3 and the real body of the performer 2. Then, recommended information is displayed on the display section of the VR glass to set the drumming instrument 3 to its recommended state and set the body of the performer 2 to its recommended state.

Another possible example is that a captured image of the real drumming instrument 3 and the body real of the performer 2 is displayed on the display section of the VR glass. Then, recommended information is displayed on the display section of the VR glass to set the drumming instrument 3 to its recommended state and set the body of the performer 2 to its recommended state. This technique is also referred to as an AR view using video see-through technology. The performer 2 is able to easily adjust to ideal settings in various virtual spaces while visually checking the recommended information displayed on the display section of the VR glass.

As has been described hereinbefore, in the drum setting assistance system 1 and the smartphone 5 according to this embodiment, recommended information is output based on the configuration information regarding the drumming instrument 3 (the drum set 4) and the body information regarding the body of the performer 2. The recommended information is regarding settings and suitable for the performer 2. Thus, the performer 2 is provided with support for setting the drumming instrument 3.

The drumming instrument 3, such as the drum set 4, provides a high degree of setting flexibility. Additionally, the setting of the drumming instrument 3 is often left to the performer 2 (user).

The high degree of setting flexibility provided by the drumming instrument 3 can be regarded as an attractive feature in that the drumming instrument 3 accommodates various forms of playing. On the other hand, since there is no definitive correct setting (goal) for the drumming instrument 3, beginners without the necessary knowledge might struggle with setting the drumming instrument 3 up, potentially taking a long time before beginners can play or even failing to reach a playable state.

Even for intermediate and advanced players, there are numerous differing opinions on the setting of the drumming instrument 3, often making it difficult to determine the best setting for individual preferences.

In a case that the performer 2 is a professional player, even with well-defined ideal settings, the performer 2 may struggle to quickly reproduce the performer 2's preferred settings.

The drum setting assistance system 1 guides the performer 2 in adjusting the settings for the drumming instrument 3 (the drum set 4), which provides a high degree of setting flexibility, to achieve the optimal configuration for the performer 2. The drum setting assistance system 1 also enhances the reproducibility of the settings. As a result, the performer 2 can significantly reduce the time needed to set up the drumming instrument 3 before beginning to play the drumming instrument 3. That is, the preparation time for setting up the drumming instrument 3 before a performance can be minimized.

The drum setting assistance system 1 also ensures that the setting of the drumming instrument 3 can be partially customized (semi-customized)) according to each performer 2's personal preferences using the standard configuration as a reference (the standard configuration is indicated by information such as a manufacturer standard value). Then, the partially customized settings can be guided for easy incorporation into the actual hardware.

By applying the drum setting assistance system 1, it is possible to provide support to a performer 2 who lacks knowledge about “drum settings that suit the performer 2”.

For example, since performer 2 has unique physical characteristics and musical preferences, the optimal settings frequently vary. For example, the performer 2 is provided with settings partially customized using the standard configuration as a reference (the standard configuration is indicated by information such as a manufacturer standard value).

The performer 2 can utilize the partially customized settings as a starting point to further develop the performer 2's ideal settings. This significantly reduces the preparation time required to achieve the ideal settings for the drumming instrument 3 and enhances the performer 2's attachment to the drumming instrument 3.

In addition, beginners or those with limited knowledge may play the drumming instrument 3 with incorrect settings. In other words, a performer 2 may start playing drumming instrument 3 without realizing if the settings are incorrect or if a part is malfunctioning.

The drum setting assistance system 1 also helps the performer 2 recognize if the performer 2 is playing the drumming instrument 3 with incorrect settings or if there is an abnormal state. This, in turn, offers the performer 2 a more comfortable playing environment.

Thus, the drum setting assistance system 1 properly supports the performer 2 from a state of not knowing what is wrong to achieving the optimal settings. The performer 2 can play the drumming instrument 3 with confidence, knowing the performer 2 has received an endorsement such as “This is OK.”

For example, when teaching students how to play the drumming instrument 3, the drum setting assistance system 1 can offer one correct answer for the settings. This provision of a correct answer is considered effective in teaching how to play the drumming instrument 3.

As illustrated in FIG. 1, the drum setting assistance system 1 can be configured with a single smartphone 5, allowing for efficient setting support that accommodates the skill level of the performer 2, from a professional drummer to an amateur drummer, including a beginner. This ensures effective drum setting assistance that suits the skill level of the performer 2.

### Output of Recommended Information Using Movable Range of Each Part of Drumming Instrument 3

The first obtainer 7 may obtain information regarding the movable range of each part of the drumming instrument 3 as the configuration information.

The information regarding the movable range encompasses any information from which an adjustable range can be determined concerning the position, height, posture, and relative positional relationship of each part of the drumming instrument 3.

The following are examples of the information regarding the movable range.

### Information Indicating Movable Range

For example, it is possible to obtain information regarding a range (area) within which the seat of the chair 27, the hitting surface of each drum, and each cymbal can be positioned or moved in a 3-dimensional space defined by a predetermined coordinate system. For another example, it is possible to use position information such as coordinates to obtain information regarding an adjustable range of height, an adjustable range of angle, or an adjustable range of position when viewed from above.

### Type of Each Stand and Type of Each Holder

The movable range of each part supported by a stand or holder often varies depending on the configuration of the stand or holder. For example, a cymbal stand 24a illustrated in FIG. 29 is a “straight-type” cymbal stand. As illustrated in FIG. 29, the cymbal stand 24a includes a pipe sleeve 49a and a cymbal sizzler 49b. The pipe sleeve 49a extends in a vertical direction. At an upper end of the pipe sleeve 49a, the crash cymbal 18 is mounted via the cymbal sizzler 49b.

The performer 2 is able to adjust the height of the crash cymbal 18 by adjusting the length of the pipe sleeve 49a, whose upper end is located approximately at the center of the crash cymbal 18. The performer 2 is also able to adjust the posture (inclination) of the crash cymbal 18 by adjusting the cymbal sizzler 49b.

In a case of the straight-type cymbal stand 24a, the upper end of the pipe sleeve 49a is located approximately at the center of the crash cymbal 18. In this positional relationship, the height and the posture (inclination) of the crash cymbal 18 is adjusted.

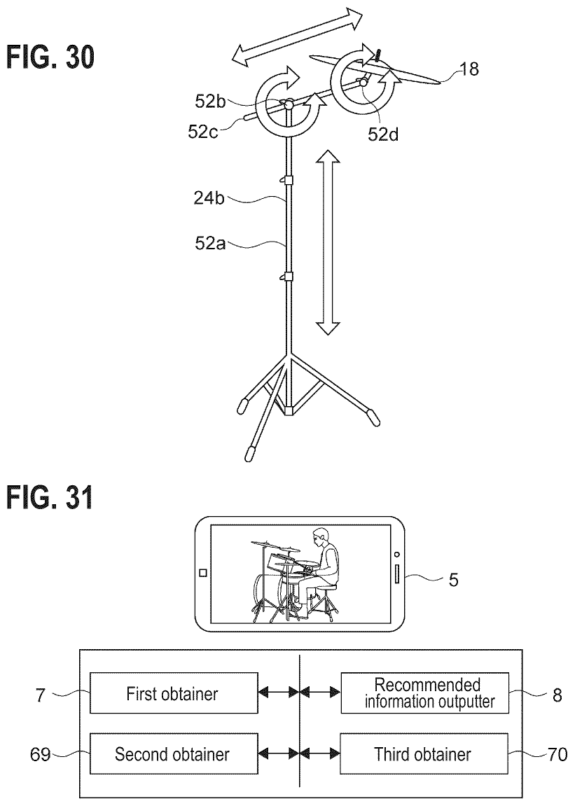

A cymbal stand 24b illustrated in FIG. 30 is a “boom-type” cymbal stand. As illustrated in FIG. 30, the cymbal stand 24b includes a pipe sleeve 52a, a cymbal sizzler 52b, a boom arm 52c, and a cymbal sizzler 52d. The pipe sleeve 52a extends in the vertical direction. At an upper end of the pipe sleeve 52a, the boom arm 52c is mounted via the cymbal sizzler 52b. At a leading end of the boom arm 52c, the crash cymbal 18 is mounted via the cymbal sizzler 52d.

The performer 2 is able to adjust the height of the crash cymbal 18 by adjusting the length of the pipe sleeve 52a, which extends in the vertical direction. The performer 2 is also able to adjust the posture (inclination) of the crash cymbal 18 by adjusting the cymbal sizzler 52d.

Also by adjusting the cymbal sizzler 52b, the performer 2 is able to adjust the part of the boom arm 52c at which the boom arm 52c is connected to the pipe sleeve 52a or the angle of the boom arm 52c.

That is, in a case of the boom-type cymbal stand 24b, the upper end of the pipe sleeve 49a is markedly positioned away from the center of the crash cymbal 18. In this positional relationship, the height and the posture (inclination) of the crash cymbal 18 is adjusted.

Thus, the movable range of each part is often determined by the configuration of each stand, each holder, and the legs supporting the drum.

Therefore, information such as the configuration of each stand (such as model number and type), the configuration of each holder (such as model number and type), and the configuration of the legs supporting the drum (such as model number and type) can be used as the information regarding the movable range.

For example, the configuration of each stand (such as model number and type), the configuration of each holder (such as model number and type), or the configuration of the legs supporting the drum (such as model number and type) can be extracted as the information regarding the movable range from a captured image including the configuration of the drum, such as the performance scene image 9 and a captured image showing only the drum set 4. In this case, the information regarding the movable range is included in the extracted information.

Another possible example is that the performer 2 inputs information such as the configuration of each stand (such as model number and type), the configuration of each holder (such as model number and type), and the configuration of the legs supporting the drum (such as model number and type) so that this information is obtained as the information regarding the movable range. In this case, the information regarding the movable range is included in the input information.

The recommended information outputter 8 outputs the recommended information based on the information regarding the movable range obtained by the first obtainer 7.

For example, an adjustable range is calculated concerning the position, height, posture, and positional relationship of each part of the drumming instrument 3 based on the information regarding the movable range. Then, the recommended information outputter 8 outputs recommended information regarding the configuration of each part of the drumming instrument 3 within the adjustable range of each part such that the recommended information is optimal for the body of the performer 2.

This allows for presenting highly accurate recommended information precisely tailored to the physique of the performer 2. For example, this approach avoids presenting as recommended information a configuration that is only feasible with the boom-type cymbal stand 24b while the performer 2 is using the straight-type cymbal stand 24a.

It is to be noted that the information regarding the movable range may be presented to the performer 2 as the recommended information.

It will be assumed that the recommended information outputter 8 performs processing using the machine learning exemplified in FIGS. 7 to 12. In this case, it is possible to output recommended information obtained from a trained model that has undergone machine learning using the information regarding the movable range as teaching data.

This enables the machine learning to accurately present recommended settings that are feasible for the physique of performer 2.

FIG. 31 is a block diagram illustrating another exemplary functional configuration of the smartphone 5.

The functional blocks of the smartphone 5 illustrated in FIG. 31 further include a second obtainer 69 and a third obtainer 70.

The second obtainer 69 and the third obtainer 70 may be implemented by an element such as the CPU executing a predetermined program, similarly to the first obtainer 7 and the recommended information outputter 8. It is of course possible to use dedicated hardware such as an IC (integrated circuit) to implement the second obtainer 69 and the third obtainer 70.

The second obtainer 69 obtains information regarding the performer 2's desired setting implemented by the performer 2.

The information regarding the desired setting is information regarding a customized setting made according to the performer 2's personal preferences. The information regarding the desired setting will be hereinafter referred to as personal customization information.

For example, the drum setting assistance system 1 outputs recommended information. For example, the performer 2 is provided with information regarding a setting partially customized using the standard configuration, which is indicated by information such as a manufacturer standard value, as a reference.

The performer 2 further adjusts the position, height, posture, or another parameter of each part of the drumming instrument 3 from the partially customized setting provided by the drum setting assistance system 1 to achieve the setting that performer 2 desires.

The second obtainer 69 obtains personal customization information, which is regarding the setting that has been personally customized by the performer 2.

For example, the performer 2 inputs into the second obtainer 69 information indicating that the performer 2 has made a desired setting. Based on the input from the performer 2, the second obtainer 69 obtains, as the personal customization information, the information regarding the personally customized setting. It is also possible for the second obtainer 69 to obtain, as the personal customization information, information indicating that how the performer 2 has moved each part according to the desired setting.

There may be a case that the performer 2 makes a desired setting and starts playing the drumming instrument 3 without informing the second obtainer 69 of the desired setting. In this case, upon start of the playing, it is possible for the second obtainer 69 to obtain, as the personal customization information, information regarding the setting at the time of the start of the playing. It is of course possible for the second obtainer 69 to obtain, as the personal customization information, such information that how the performer 2 has moved each part before the start of the playing.

The recommended information outputter 8 outputs recommended information based on the personal customization information obtained by the second obtainer 69.

For example, the recommended information outputter 8 outputs recommended configuration information and recommended body information each indicating a recommended state tailored through personal customization to achieve the performer 2's desired setting. This enables the performer 2 to easily reproduce the performer 2's customized settings when playing the drumming instrument 3 on subsequent occasions.

For example, a performer 2 (for example, a professional player) with fixed preferences can quickly reproduce the performer 2's favorite settings.

It will be assumed that the recommended information outputter 8 performs processing using the machine learning exemplified in FIGS. 7 to 12. In this case, it is possible to output recommended information obtained from a trained model that has undergone machine learning using the customization information (information regarding the desired settings) as teaching data.

This enables the machine learning to accurately reproduce desired settings as personally customized by the performer 2.

The third obtainer 70 obtains answer information from the performer 2. The answer information indicates an answer to a questionnaire regarding the playing of the drumming instrument 3.

For example, the touch panel 6 displays questionnaires about preferred musicians, preferred music genres, preferred settings, drumming experience, skill level (beginner, intermediate, advanced, professional), and playing environment. The performer 2 operates the touch panel 6 to input answer information indicating an answer to each questionnaire.

There is no limitation to how the questionnaires are presented to the performer 2; any GUI or alternative method, such as audio announcements, can be used.

The recommended information outputter 8 outputs the recommended information based on the answer information obtained by the third obtainer 70.

For example, the configuration information and the body information obtained by the first obtainer 7 may be updated (corrected) based on the answer information. For example, configuration information obtained from a captured image of the drumming instrument 3 is updated based on the answer information regarding the favorite settings. This ensures drum setting assistance using highly accurate configuration information.

Also, at the time of generating recommended information, the recommended state serving as a reference of the recommended information may be updated (corrected) based on the answer information. For example, the recommended state is updated to closely match the preferences of the favorite musician. This that the settings align with the performer 2's preferences. It is also possible to adjust the recommended state based on the performer 2's skill level.

It is also possible to adjust the recommended state based on the favorite genre. For example, for a performer 2 who prefers very fast BPM (Beats Per Minute) songs, a setting advantageous for high-speed performance is established as the recommended state. Specifically, a setting where the chair 27 is relatively elevated to enable fine, detailed performance of the bass drum 12 (kick pedal 20) may be established as the recommended state.

In contrast, for a performer 2 who prefers songs with slower BPM (Beats Per Minute), a power-emphasizing setting is established as the recommended state. Specifically, setting where the chair 27 is relatively lowered to allow the bass drum 12 (kick pedal 20) to be played with greater volume may be established as the recommended state.

It will be readily appreciated that these settings are not intended in a limiting sense. Recommended states, such as those regarding the height of the snare drum 13 and the hi-hat cymbal 17, can be adjusted as needed to make playing preferred genre songs easier.

It will be assumed that the recommended information outputter 8 performs processing using the machine learning exemplified in FIGS. 7 to 12. In this case, it is possible to output recommended information obtained from a trained model that has undergone machine learning using the answer information as teaching data. Another possible example is that the trained model used is selected as necessary based on the answer information.

This enables the machine learning to accurately realize settings aligning with the performer 2's preferences.

In this embodiment, the third obtainer 70 serves as an answer information obtainer.

Also, the answer information indicating an answer to a questionnaire can also be referred to as preference information indicating the performer 2's preference.

In the drum setting assistance system 1, recommended information output for each performer 2 or a recommended state set for each performer 2 may be stored linked to identification information (ID) that uniquely identifies each performer 2. The identification information can be retrieved based on instructions from the performer 2 or another user.

For example, information regarding a setting partially customized by the drum setting assistance system 1 for a performer 2 is stored as the recommended information. Alternatively, information regarding a setting personally customized for this performer 2 is stored as the recommended information.

In a studio or a concert venue where the performer 2 will play the drumming instrument 3, a staff member or a drum technician can access the drum setting assistance system 1 to retrieve setting information linked to the performer 2. Then, the drumming instrument 3 is set in accordance with the retrieved setting information.

This significantly shortens the time before the performer 2 starts playing the drumming instrument 3 in a studio or a concert venue. This enables the performer 2 to start playing the drumming instrument 3 in a studio or a concert venue with settings for optimized for the performer 2. This significantly shortens the time required for rehearsals and pre-performance preparations, thereby increasing the likelihood of a successful performance.

Additionally, for practice studios and similar venues, this effect can be promoted as an added value for customers, potentially leading to increased sales.

Another possible example is to store a history of information regarding settings optimized for the performer 2 so that the information can be retrieved and output based on instructions from the performer 2 or another user.

Reviewing the history of information regarding optimal settings helps improve the performer 2's playing of the drumming instrument 3. Also, the history of information regarding optimal settings can serve as a reference when defining the desired direction and goal for the performer 2.

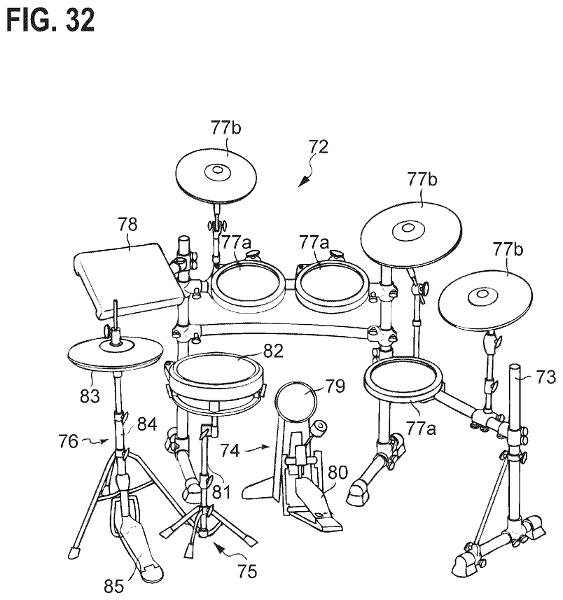

FIG. 32 is a schematic illustration of an example configuration of electronic drums 72.

As illustrated in FIG. 32, the electronic drums 72 include a stand (rack) 73, a kick unit (bass drum unit) 74, a snare unit 75, and a hi-hat unit 76. The electronic drums 72 also include a chair (not illustrated) for the performer 2 to sit on during performance.

Pads 77a, pads 77b, and a controller 78 are detachably attached to the stand 73. The pads 77a are for the high tom, the low tom, and the floor tom, respectively. The pads 77b are for the crash cymbal and the ride cymbal, respectively.

The kick unit 74 includes a bass drum pad 79 and a kick pedal 80.

The snare unit 75 includes a snare stand 81 and a snare drum pad 82.

The hi-hat unit 76 includes a hi-hat cymbal pad 83, a hi-hat stand 84, and a hi-hat pedal 85.

Each pad is provided with a strike sensor (or a drum pad sensor), not illustrated. The strike sensor detects vibration caused by the performer 2's playing (striking) of the each pad and outputs the vibration as a strike signal to the controller 78.

The controller 78 generates a performance sound (striking sound) based on the strike signal output from the strike sensor of the each pad, and outputs the performance sound. For example, when the pad 77a for the high tom, the pad 77a for the low tom, and the pad 77a for the floor tom are struck, the controller 78 generates a performance sound of the high tom, a performance sound of the low tom, and a performance sound of the floor tom. Then, the controller 78 outputs these performance sounds.

For another example, when the pad 77b for the crash cymbal and the pad 77b for the ride cymbal are struck, the controller 78 generates a performance sound of the crash cymbal and a performance sound of the ride cymbal. Then, the controller 78 outputs these performance sounds.

For another example, when the bass drum pad 79, the snare drum pad 82, and the hi-hat cymbal pad 83 are struck, the controller 78 generates a performance sound of the bass drum, a performance sound of the snare drum, and a performance sound of the hi-hat cymbals. Then, the controller 78 outputs these performance sounds.

By operating the controller 78, the performer 2 can precisely control the tone, response, length, and other characteristics of the notes played on the each pad.

The above-described embodiment is also applicable to the settings of the electronic drums 72 exemplified in FIG. 32. That is, using the drum setting assistance system 1, it is possible to output recommended configuration information regarding the positions, the heights, and the postures of the pads 77a and 77b relative to the stand 73. Also using the drum setting assistance system 1, it is possible to output recommended configuration information regarding the position and the height of the chair, the position of the kick unit 74, the position of the snare stand 81, the height of the snare drum pad 82, the position of the hi-hat stand 84, and the height of the hi-hat cymbal pad 83.

Also using the drum setting assistance system 1, it is possible to output recommended body information regarding a recommended posture the body of the performer 2 when playing the electronic drums 72.

As a result, the same effects described above can be achieved, fully supporting the setting of the electronic drums 72.

For example, in a case that the pads 77a and 77b are temporarily assembled on the stand 73, a possible example of setting assistance is to provide the pads 77a and 77b with recommended setting adjustments from this temporarily assembled state to suit the body of the performer 2.

The learning sections exemplified in FIGS. 8 to 12 may cause the trained models to learn using any computer such as a PC. Specifically, a generator according to the embodiment generates a trained model that has undergone machine learning to estimate recommended information, and this generator may be implemented by any computer.

A generation program according to the embodiment is a program for generating a trained model that has undergone machine learning to estimate recommended information. Based on this generation program, a processor included in the computer may perform a generation method according to the embodiment for generating the trained model that has undergone the machine learning to estimate the recommended information.

The following are configuration examples of the generator according to the embodiment.

(1) A generator that generates a trained model. The trained model receives, as input, at least one of configuration information regarding a configuration of a drumming instrument or body information regarding a body of a performer playing the drumming instrument. Based on the input, the trained model estimates recommended information regarding a setting for playing the drumming instrument and corresponding to the performer.

(2) The generator described in (1) trains the model to undergo machine learning using, as teaching data, the recommended information and at least one of the configuration information or the body information. In this manner, the generator generates the trained model.

(3) The generator described in (1) trains the trained model to undergo machine learning using, as teaching data, the recommended information and a captured image of the performer playing the drumming instrument. In this manner, the generator generates the trained model.

(4) The generator described in (1) trains the model to undergo machine learning using, as teaching data, the recommended information and extracted information extracted from the captured image of the performer playing the drumming instrument. In this manner, the generator generates the trained model.

The methods of the processings described in (1) to (4) are examples of the generation method according to the embodiment. Programs for performing the processings described in (1) to (4) are examples of the generation program according to the embodiment.

It will be readily appreciated that the generator, the generation method, and the generation program according to the embodiment will not be limited to (1) to (4).

The learning sections exemplified in FIGS. 8 to 12 may be incorporated in the smartphone 5 illustrated in FIG. 1 or any other examples of the information processing apparatus according to the embodiment. In this case, the information processing apparatus according to the embodiment also functions as the generator according to the embodiment.

In this case, a single device (a single system) performs the learning stage, in which the trained model is caused to learn, and the execution stage, in which recommended information is output using the trained model.

It is also possible that the generator according to the embodiment is implemented by a computer different from the information processing apparatus, and that the generation method according to the embodiment is performed based on the generation program according to the embodiment. In this case, the trained model generated by the generator is incorporated in the recommended information outputter of the information processing apparatus according to the embodiment.

In this case, different devices (systems) perform the learning stage, in which the trained model is caused to learn, and the execution stage, in which recommended information is output using the trained model.

It is to be noted that the “teaching data” may also be referred to as “training data”. It is also to be noted that the expressions “to cause a trained model to learn”, “causing a trained model to learn”, and “a trained model is caused to learn” may also be referred to as “to train a learning model to learn”, “training a learning model to learn”, and “a learning model is trained to learn”, respectively.

For example, the expression “a computer causes a trained model to learn using teaching data” may also be referred to as “a computer trains a learning model to learn using teaching data”.

A drum setting assistance system according to another embodiment obtains any one of configuration information or body information, and outputs recommended information (recommended configuration information or recommended body information) based on the configuration information or the body information that has been obtained.

For example, only the configuration information may be obtained, recommended information (recommended configuration information or recommended body information) may be output based on the configuration information that has been obtained. In contrast, only the body information may be obtained, and recommended information (recommended configuration information or recommended body information) may be output based on the body information that has been obtained.

For example, default settings may include information about the performer's body (such as average height and average weight), and the recommended information may be output based solely on the input of the configuration information. Another possible example is that the recommended information is output based solely on the input of the configuration information, assuming that the performer has an average body type.

For example, default settings may include information about drum type (such as type, name, manufacturer, and model number), and the recommended information may be output based solely on the input of the configuration information the body information. For example, in a service for playing a specific drum set, recommended information may be output based solely on the input of the performer's body information.

Another possible example is that for the various kinds of configuration information described above, related recommended information may be output based solely on the input of configuration information. Another possible example is that for the various kinds of body information described above, related recommended information may be output based solely on the input of body information.

When each of the performance scene image 9, the captured image of the drumming instrument 3, and the captured image of the performer 2 are captured, it is possible to output guide information that guides the each image. Examples of the guide information include “Please capture the image from the front of the drum set”, “Please capture the image from behind the performer, ensuring that the entire snare drum is included”, “Please capture the image, ensuring that the entire body is included”, and any other information that instructs the performer 2 on how to capture the image.

In the example illustrated in FIG. 1, is the smartphone 5 is used as one embodiment of the information processing apparatus. That is, a computer with an imaging function is used as one embodiment of the information processing apparatus.

This configuration, however, is not intended in a limiting sense. Another possible example is that the drum setting assistance system 1 is implemented by a computer, such as a PC, and an image pick-up device connected to the computer wirelessly or via a wire so that the computer and image pick-up device can communicate with each other. In a case of using the computer and the image pick-up device that are mutually communicative, the computer serves as one embodiment of the information processing apparatus.

There is no limitation to the type of connection between the computer and the image pick-up device. Examples include a wireless local area network (LAN) such as Wi-Fi and near-field wireless communication such as Bluetooth (registered trademark).

There may be a case that the configuration information or the body information obtained at step 101 illustrated in FIG. 2 is information other than a captured image or extracted information extracted from the captured image. In this case, a computer without an imaging function may serve as one embodiment of the drum setting assistance system.

That is, in one embodiment, the drum setting assistance system may not include an imaging function.

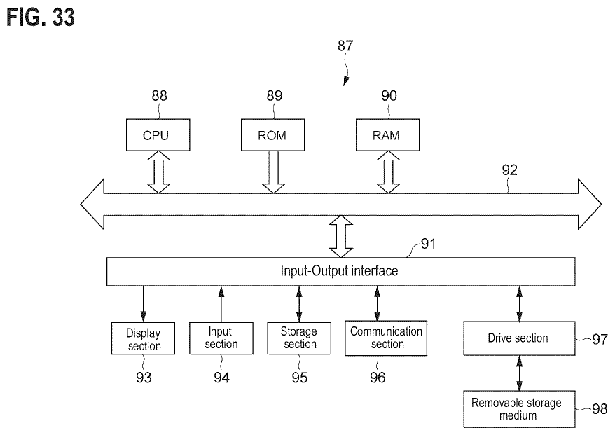

FIG. 33 is a block diagram illustrating an example hardware configuration of a computer 87. The computer 87 can be used as the information processing apparatus according to the embodiment.

The computer 87 includes a CPU 88, a ROM 89, a RAM 90, an Input-Output interface 91, and a bus 92. The bus 92 connects these elements to each other. The Input-Output interface 91 is connected with a display section 93, an input section 94, a storage section 95, a communication section 96, and a drive section 97.

The display section 93 is a display device using material such as liquid crystal and EL (Electroluminescence). The input section 94 is an operation device such as a keyboard, a pointing device, and a touch panel. In a case that the input section 94 includes a touch panel, the touch panel may be integral to the display section 93.

The storage section 95 is a nonvolatile storage device, examples including an HDD and a solid-state memory such as a flash memory. The drive section 97 is a device capable of driving a removable storage medium 98. Examples of the storage medium 98 include an optical storage medium and a magnetic recording tape.

The communication section 96 is a modem, a router, or any other communication device that is connectable a LAN (local area network) and/or a Wide Area Network (WAN) and that is communicable with other devices. The communication section 96 may communicate with other devices through a wire or wirelessly. The communication section 96 is in many cases used in a form separate from the computer 87.

With the above-described hardware configuration, the computer 87 performs information processing through a collaborative operation of software stored in the storage section 95 or the ROM 89 and the hardware resources of the computer 87. Specifically, a program constituting the software stored in a storage such as the ROM 89 is loaded and executed in the RAM 90 to implement the method for processing information according to the present disclosure.

The program is installed in the computer 87 via, for example, the storage medium 98. Another possible example is that the program is installed in the computer 87 via a network such as a global network. Another possible example is to use any non-transitory computer-readable storage medium.

In the above-described embodiment, a plurality of computers connected to each other communicatively via a network or by any other wired or wireless method may cooperate to perform the program according to the present disclosure and the method for processing information according to the present disclosure (specifically, a drum setting assistance method). The information processing apparatus according to the present invention may be constructed in this manner.

That is, the method for processing information according to the present disclosure and the program according to the present disclosure can be performed not only by a computer system made up of a single computer but also by a computer system made up of a plurality of cooperating computers.

In the present disclosure, the term “system” is intended to mean a collection of a plurality of elements or components, such as apparatuses, devices, modules (including parts and members). This definition applies irrespective of whether all the elements or components are housed within the same enclosure. Specifically, a plurality of apparatuses or devices connected to each other via a network and housed within separate enclosures make up a system; and a single apparatus or device with a plurality of modules housed within a single enclosure is a system.

The computer system-implemented method for processing information according to the present disclosure and the computer system-implemented program according to the present disclosure encompass a case that a single computer obtains the configuration information and the body information, outputs the recommended information, obtains the captured image, extracts the extracted information, obtains information regarding a desired setting, and obtains the answer information; and a case that different computers perform these processings. In a case that a predetermined computer performs these processings, the predetermined computer may cause another computer to perform one, some, or all of the processings to obtain a result of the one, some, or all of the processings. This configuration is encompassed within the computer system-implemented method for processing information according to the present disclosure and the computer system-implemented program according to the present disclosure.

That is, the program and method for processing information according to the present disclosure is applicable to a cloud computing configuration in which a plurality of apparatuses or devices cooperate via a network to perform a single function.

By referring to the accompanying drawings, description has been made with regard to the drum setting assistance system, the information processing apparatus, the smartphone, the GUI configurations for outputting the recommended information, and the steps of generating and outputting the recommended information. These system, apparatus, device, configurations, and steps have been presented only for the purpose of illustration and description, and it is to be understood that various changes, modifications, and rearrangements can be made without departing from the concept of the present disclosure. That is, the present disclosure will not be limited to the specific configurations or algorithms described herein; it is to be understood that other configurations or algorithms can be employed without departing from the concept of the present disclosure.

In the present disclosure, approximating language such as “approximately”, “about”, and “substantially” may be applied to modify any quantitative representation that could permissibly vary without a significant change in the final result obtained.

That is, in the present disclosure, terms that describe shape, size, position, and condition are employed in the present disclosure, including “center”, “middle”, “uniform”, “equal”, “same”, “orthogonal”, “parallel”, “symmetry”, “extending”, “axial”, “solid-cylindrical”, “hollow-cylindrical”, “ring-shaped”, and “toroidal”. All these terms recited in the present application shall be construed to be modified by approximating language such as “approximately”, “about”, and “substantially”, such as “substantially center”, “substantially middle”, “substantially uniform”, “substantially equal”, “substantially same”, “substantially orthogonal”, “substantially parallel”, “substantially symmetry”, “substantially extending”, “substantially axial”, “substantially solid-cylindrical”, “substantially hollow-cylindrical”, “substantially ring-shaped”, and “toroidal”.

For example, the terms “center”, “middle”, “uniform”, “equal”, “same”, “orthogonal”, “parallel”, “symmetry”, “extending”, “axial”, “solid-cylindrical”, “hollow-cylindrical”, “ring-shaped”, and “toroidal” shall be construed as being within 10% deviation from a state of “completely center”, “completely center”, “completely uniform”, “completely equal”, “completely similar”, “completely orthogonal”, “completely parallel”, “completely symmetry”, “completely extending”, “completely axial”, “completely solid-cylindrical”, “completely hollow-cylindrical”, “completely ring-shaped”, and “completely toroidal”, respectively.

Thus, terms not modified by approximating language such as “approximately”, “about”, and “substantially” shall be construed to be modified by approximating language such as “approximately”, “about”, and “substantially”. It is to be noted, however, that terms modified by approximating language such as “approximately”, “about”, and “substantially” may not necessarily exclude a complete state.

In the present disclosure, comparative expressions using “than”, such as “larger than A” and “smaller than A”, shall be construed to comprehensively include both a case of “equal to A” and a case excluding “equal to A”. For example, the expression “larger than A” includes not only a case excluding “equal to A” but also a case of “A or more”. For another example, the expression “smaller than A” includes not only a case of “less than A” but also a case of “A or less”.

In order to maximize the effects of the present disclosure, specific settings may be adjusted as necessary based on the concepts of “larger than A” and “smaller than A” described above.

It is possible to combine at least two features of the above-described features of the embodiment. That is, the various features described in the embodiment may be combined in any manner, irrespective of their original embodiment. It will be readily appreciated that the various effects described above have been presented solely for illustration and description; the embodiment may produce other effects not explicitly illustrated herein.

While embodiments of the present disclosure have been described, the embodiments are intended as illustrative only and are not intended to limit the scope of the present disclosure. It will be understood that the present disclosure can be embodied in other forms without departing from the scope of the present disclosure, and that other omissions, substitutions, additions, and/or alterations can be made to the embodiments. Thus, these embodiments and modifications thereof are intended to be encompassed by the scope of the present disclosure. The scope of the present disclosure accordingly is to be defined as set forth in the appended claims.

What is claimed is:

1. An information processing apparatus comprising:
a first obtainer configured to obtain:
configuration information regarding a configuration of a drumming instrument; and
body information regarding a body of a performer playing the drumming instrument; and
a recommended information outputter configured to output recommended information based on the configuration information and the body information obtained by the first obtainer, the recommended information being regarding a setting for playing the drumming instrument and corresponding to the performer.

2. The information processing apparatus according to claim 1, wherein the recommended information outputter is configured to obtain the recommended information from a trained model by inputting at least one of the configuration information or the body information into the trained model, the trained model having been subjected to machine learning to estimate the recommended information.

3. The information processing apparatus according to claim 1, wherein the recommended information includes at least one of:
recommended configuration information regarding a recommended configuration of the drumming instrument for the body of the performer in playing the drumming instrument; or
recommended body information regarding a recommended posture of the body of the performer in playing the drumming instrument.

4. The information processing apparatus according to claim 1, wherein the first obtainer is configured to obtain at least one of:
a captured image including at least one of the configuration of the drumming instrument or the body of the performer;
extracted configuration information extracted from the captured image and regarding the configuration of the drumming instrument;
extracted body information extracted from the captured image and regarding the body of the performer;
input configuration information input from the performer and regarding the configuration of the drumming instrument; or
input body information input from the performer and regarding the body of the performer.

5. The information processing apparatus according to claim 1, wherein
the first obtainer is configured to obtain, as the configuration information, information regarding a movable range of each of parts of the drumming instrument, and
the recommended information outputter is configured to output the recommended information based on the information regarding the movable range and obtained by the first obtainer.

6. The information processing apparatus according to claim 5, wherein the recommended information outputter is configured to output the recommended information using a trained model that has undergone machine learning using the information regarding the movable range as teaching data.

7. The information processing apparatus according to claim 3, wherein the recommended configuration information includes at least one of:
a position of each of parts of the drumming instrument;
a height of the each part of the drumming instrument;
a posture of the each part of the drumming instrument; or
a positional relationship between the parts of the drumming instrument, and the recommended body information includes at least one of:
a position of each of parts of the body of the performer;
a height of the each part of the body of the performer;
a posture of the each part of the body of the performer; or
a positional relationship between the parts of the body of the performer.

8. The information processing apparatus according to claim 3, wherein the drumming instrument is a drum set, and
the recommended configuration information includes information regarding at least one of:
a position and a height of a chair;
a position and an inclination of a bass drum;
a position, a height, and an inclination of a snare drum;
a position and a height of a hi-hat cymbal;
a position, a height, and an inclination of a floor tom;
a position, a height, and an inclination of a tom;
a position, a height, and an inclination of a cymbal; or
a difference between the height of the snare drum and the height of the hi-hat cymbal.

9. The information processing apparatus according to claim 3, wherein the drumming instrument is a drum set, and
the recommended body information includes information regarding at least one of:
an angle of a thigh of the performer sitting on a chair;
a positional relationship between a bass drum and a leg of the performer playing the bus drum;
an angle of a shin of the leg of the performer playing the bus drum;
a positional relationship between a snare drum and the body of the performer;
a positional relationship between an upper arm and the body of the performer playing the snare drum;
a relationship between a height of the snare drum, a height of an elbow of the performer, and a height of a knee of the performer;
a positional relationship between a hi-hat cymbal and the leg of the performer playing the hi-hat cymbal;
the angle of the shin of the leg of the performer playing the hi-hat cymbal;
a positional relationship between a floor tom and the body of the performer;
a positional relationship between a tom and an arm of the performer; or
a positional relationship between a cymbal and the arm of the performer.

10. The information processing apparatus according to claim 1, wherein the recommended information outputter is configured to output, as the recommended information, difference information indicating a difference between the configuration information and standard configuration information indicating a standard configuration for the drumming instrument.

11. The information processing apparatus according to claim 1, wherein the recommended information outputter is configured to output the recommended information based on a motion of arranging parts of the drumming instrument in order.

12. The information processing apparatus according to claim 3, wherein the recommended information outputter is configured to display, as the recommended configuration information, a virtual image of the drumming instrument superimposed over a real image of the drumming instrument.

13. The information processing apparatus according to claim 3 wherein the recommended information outputter is configured to display, as the recommended body information, a virtual image of the body of the performer superimposed over a real image of the body of the performer.

14. The information processing apparatus according to claim 1, further comprising a second obtainer configured to obtain information regarding a desired setting desired by the performer and carried out by the performer,
wherein the recommended information outputter is configured to output the recommended information based on the information regarding the desired setting obtained by the second obtainer.

15. The information processing apparatus according to claim 14, wherein the recommended information outputter is configured to output the recommended information using a trained model that has undergone machine learning using the information regarding the desired setting as teaching data.

16. The information processing apparatus according to claim 1, further comprising an answer information obtainer configured to obtain answer information indicating an answer to a questionnaire that is about playing of the drumming instrument and that is input from the performer,
the recommended information outputter is configured to output the recommended information based on the answer information obtained by the answer information obtainer.

17. A computer system-implemented method of processing information, the method comprising:
obtaining:
configuration information regarding a configuration of a drumming instrument; and
body information regarding a body of a performer playing the drumming instrument; and
outputting recommended information based on the configuration information and the body information that have been obtained, the recommended information being regarding a setting for playing the drumming instrument and corresponding to the performer.

18. A non-transitory computer-readable storage medium storing a program which, when executed by at least one processor, causes the at least one processor to:
obtain:
configuration information regarding a configuration of a drumming instrument; and
body information regarding a body of a performer playing the drumming instrument; and
output recommended information based on the configuration information and the body information that have been obtained, the recommended information being regarding a setting for playing the drumming instrument and corresponding to the performer.
